(19) United States
(12) Patent Application Publication
(10) Pub. No.: US 2003/0089847 A1
(43) Pub. Date: May 15, 2003

(54) Tandem high field asymmetric waveform ion mobility spectrometry ( faims)/ion mobility spectrometry

(76) Inventors: Roger Guevremont, Ontario (CA); Randy Purves, Ontario (CA); David Barnett, Ontario (CA)

Correspondence Address: Freedman & Associates, Suite 350, 117 Centrepointe Drive, Nepean, ON, K2G 5X3, CA

(21) Appl. No.: 10/220,603

(22) PCT Filed: Mar. 14, 2001
(86) PCT No.: PCT/CA01/00315

(51) Int. Cl. H01J 49/40

(52) U.S. Cl. 250/282; 250/287

(57) ABSTRACT

A method for seperating ions is disclosed. A first analyzer region is provided defined by a space between first and second spaced apart electrodes. A second analyser region is defined in operational communication with the first analyzer region and having two electrodes. Ions are provided to one of the first analyzer region and the second analyzer region and then coupled from there to the other analyzer region. A first asymmetric waveform and a first direct-current compensation voltage are applied to electrodes for providing an electric field within the first analyzer region. The first asymmetric waveform is typically selected for effecting a difference in net displacement between two different ions in the time of one cycle of the applied first asymmetric waveform and the first compensation voltage is selected to support selective transmission of a first subset of the ions within the first analyzer region. Conditions are provided within the second analyzer region for effecting a second separation of ions therein to support selective transmission of a second subset of the ions within the second analyzer region.

### FIELD OF THE INVENTION

The present invention relates to an apparatus and method for separating ions, more particularly the present invention relates to an apparatus and method for separating ions based on the ion focusing principles of high field asymmetric waveform ion mobility spectrometry (FAIMS).

### BACKGROUND OF THE INVENTION

High sensitivity and amenability to miniaturization for field-portable applications have helped to make ion mobility spectrometry (IMS) an important technique for the detection of many compounds, including narcotics, explosives, and chemical warfare agents as described, for example, by G. Eiceman and Z. Karpas in their book entitled “Ion Mobility Spectrometry” (CRC, Boca Raton, 1994). In IMS, gas-phase ion mobilities are determined using a drift tube with a constant electric field. Ions are gated into the drift tube and are subsequently separated in dependence upon differences in their drift velocity. The ion drift velocity is proportional to the electric field strength at low electric field strength, for example 200 V/cm, and the mobility, K, which is determined from experimentation, is independent of the applied electric field. Additionally, in IMS the ions travel through a bath gas that is at sufficiently high pressure such that the ions rapidly reach constant velocity when driven by the force of an electric field that is constant both in time and location. This is to be clearly distinguished from those techniques, most of which are related to mass spectrometry, in which the gas pressure is sufficiently low that, if under the influence of a constant electric field, the ions continue to accelerate.

E. A. Mason and E. W. McDaniel in their book entitled “Transport Properties of Ions in Gases” (Wiley, New York, 1988) teach that at high electric field strength, for instance fields stronger than approximately 5,000 V/cm, the ion drift velocity is no longer directly proportional to the applied field, and K becomes dependent upon the applied electric field. At high electric field strength, K is better represented by Kₕ, a non-constant high field mobility term. The dependence of Kₕ on the applied electric field has been the basis for the development of high field asymmetric waveform ion mobility spectrometry (FAIMS), a term used by the inventors throughout this disclosure, and also referred to as transverse field compensation ion mobility spectrometry, or field ion spectrometry. Ions are separated in FAIMS on the basis of a difference in the mobility of an ion at high field strength, Kₕ, relative to the mobility of the ion at low field strength, K. In other words, the ions are separated because of the compound dependent behavior of Kₕ as a function of the applied electric field strength. FAIMS offers a new tool for atmospheric pressure gas-phase ion studies since it is the change in ion mobility, and not the absolute ion mobility, that is being monitored.

The principles of operation of FAIMS using flat plate electrodes have been described by I. A. Buryakov, E. V. Krylov, E. G. Nazarov and U. Kh. Rasulev in a paper published in the International Journal of Mass Spectrometry and Ion Processes; volume 128 (1993), pp. 143-148, the contents of which are herein incorporated by reference. The mobility of a given ion under the influence of an electric field is expressed by: Kₕ=K(1+f(E)), where Kₕ is the mobility of an ion at high electrical field strength, K is the coefficient of ion mobility at low electric field strength and f(E) describes the functional dependence of the ion mobility on the electric field strength. Ions are classified into one of three broad categories on the basis of a change in ion mobility as a function of the strength of an applied electric field, specifically: the mobility of type A ions increases with increasing electric field strength; the mobility of type C ions decreases; and, the mobility of type B ions increases initially before decreasing at yet higher field strength. The separation of ions in FAIMS is based upon these changes in mobility at high electric field strength. Consider an ion, for example a type A ion, which is being carried by a gas stream between two spaced-apart parallel plate electrodes of a FAIMS device. The space between the plates defines an analyzer region in which the separation of ions occurs. The net motion of the ion between the plates is the sum of a horizontal x-axis component due to the flowing stream of gas and a transverse y-axis component due to the electric field between the parallel plate electrodes. The term “net motion” refers to the overall translation that the ion, for instance said type A ion, experiences, even when this translational motion has a more rapid oscillation superimposed upon it. Often, a first plate is maintained at ground potential while the second plate has an asymmetric waveform, V(t), applied to it. The asymmetric waveform V(t) is composed of a repeating pattern including a high voltage component, V₁, lasting for a short period of time t₂ and a lower voltage component, V₂, of opposite polarity, lasting a longer period of time t₁. The waveform is synthesized such that the integrated voltage-time product, and thus the field-time product, applied to the plate during each complete cycle of the waveform is zero, for instance V₁t₂+V₂t₁=0; for example +2000 V for 10 μs followed by −1000 V for 20 μs. The peak voltage during the shorter, high voltage portion of the waveform is called the “dispersion voltage” or DV in this disclosure.

During the high voltage portion of the waveform, the electric field causes the ion to move with a transverse y-axis velocity component v₁=KₕE_{high}, where E_{high} is the applied field, and Kₕ is the high field ion mobility under ambient electric field; pressure and temperature conditions. The distance traveled is d₁=v₁t₂=KₕE_{high}t₂, where t₂ is the time period of the applied high voltage. During the longer duration, opposite polarity, low voltage portion of the asymmetric waveform, the y-axis velocity component of the ion is v₂=KE_{low}, where K is the low field ion mobility under ambient pressure and temperature conditions. The distance traveled is d₂=v₂t₁=KE_{low}t₁. Since the asymmetric waveform ensures that (V₁t₂)+(V₂t₁)=0, the field-time products E_{high}t₂ and E_{low}t₁ are equal in magnitude. Thus, if Kₕ and K are identical, d₁ and d₂ are equal, and the ion is returned to its original position along the y-axis during the negative cycle of the waveform, as would be expected if both portions of the waveform were low voltage. If at E_{high} the mobility Kₕ>K, the ion experiences a net displacement from its original position relative to the y-axis. For example, positive ions of type A travel farther during the positive portion of the waveform, for instance d₁>d₂, and the type A ion migrates away from the second plate. Similarly, positive ions of type C migrate towards the second plate.

If a positive ion of type A is migrating away from the second plate, a constant negative dc voltage can be applied to the second plate to reverse, or to “compensate” for, this transverse drift. This dc voltage, called the “compensation voltage” or CV in this disclosure, prevents the ion from migrating towards either the second or the first plate. If ions derived from two compounds respond differently to the applied high strength electric fields, the ratio of Kₕ to K may be different for each compound. Consequently, the magnitude of the CV necessary to prevent the drift of the ion toward either plate is also different for each compound. Thus, when a mixture including several species of ions is being analyzed by FAIMS, only one species of ion is selectively transmitted for a given combination of CV and DV. The remaining species of ions, for instance those ions that are other than selectively transmitted through FAIMS, drift towards one of the parallel plate electrodes of FAIMS and are neutralized. Of course, the speed at which the remaining species of ions move towards the electrodes of FAIMS depends upon the degree to which their high field mobility properties differ from those of the ions that are selectively transmitted under the prevailing conditions of CV and DV.

An instrument operating according to the FAIMS principle as described previously is an ion filter, capable of selective transmission of only those ions with the appropriate ratio of Kₕ to K. In one type of experiment using FAIMS devices, the applied CV is scanned with time, for instance the CV is slowly ramped or optionally the CV is stepped from one voltage to a next voltage, and a resulting intensity of transmitted ions is measured. In this way a CV spectrum showing the total ion current as a function of CV, is obtained. It is a significant limitation of early FAIMS devices, which used electrometer detectors, that the identity of peaks appearing in the CV spectrum are other than unambiguously confirmed solely on the basis of the CV of transmission of a species of ion. This limitation is due to the unpredictable, compound-specific dependence of Kₕ on the electric field strength. In other words, a peak in the CV spectrum is easily assigned to a compound erroneously, since there is no way to predict or even to estimate in advance, for example from the structure of an ion, where that ion should appear in a CV spectrum. In other words, additional information is necessary in order to improve the likelihood of assigning correctly each of the peaks in the CV spectrum. For example, subsequent mass spectrometric analysis of the selectively transmitted ions greatly improves the accuracy of peak assignments of the CV spectrum.

In U.S. Pat. No. 5,420,424 which issued on May 30, 1995, B. L. Carnahan and A. S. Tarassove disclose an improved FAIMS electrode geometry in which the flat plates that are used to separate the ions are replaced with concentric cylinders, the contents of which are herein incorporated by reference. The concentric cylinder design has several advantages, including higher sensitivity compared to the flat plate configuration, as was discussed by R. W. Purves, R. Guevremont, S. Day, C. W. Pipich, and M. S. Matyjaszczyk in a paper published in Reviews of Scientific Instruments; volume 69 (1998), pp 4094-4105. The higher sensitivity of the cylindrical FAIMS is due to a two-dimensional atmospheric pressure ion focusing effect that occurs in the analyzer region between the concentric cylindrical electrodes. When no electrical voltages are applied to the cylinders, the radial distribution of ions should be approximately uniform across the FAIMS analyzer. During application of DV and CV, however, the radial distribution of ions is not uniform across the annular space of the FAIMS analyzer region. Advantageously, with the application of an appropriate DV and CV for an ion of interest, those ions become focused into a band between the electrodes and the rate of loss of ions, as a result of collisions with the FAIMS electrodes, is reduced. The efficiency of transmission of the ions of interest through the analyzer region of FAIMS is thereby improved as a result of this two-dimensional ion focusing effect.

The focussing of ions by the use of asymmetric waveforms has been discussed above. For completeness, the behavior of those ions that are not focussed within the analyzer region of a cylindrical geometry FAIMS is described here, briefly. As discussed previously, those ions having high field ion mobility properties that are other than suitable for focussing under a given set of DV, CV and geometric conditions will drift toward one or another wall of the FAIMS device. The rapidity with which these ions move towards the wall depends on the degree to which their Kₕ/K ratio differs from that of the ion that is transmitted selectively under the prevailing conditions. At the very extreme, ions of completely the wrong property, for instance a type A ion versus a type C ion, are lost to the walls of the FAIMS device very rapidly.

The loss of ions in FAIMS devices should be considered one more way. If an ion of type A is focussed, for example at DV 2500 volts, CV −11 volts in a given geometry, it would seem reasonable to expect that the ion is also focussed if the polarity of DV and CV are reversed, for instance DV of −2500 volts and CV of +11 volts. This, however, is not observed and in fact the reversal of polarity in this manner creates a mirror image effect of the ion-focussing behavior of FAIMS. The result of such polarity reversal is that the ions are not focussed, but rather are extremely rapidly rejected from the device,. The mirror image of a focussing valley, is a hill-shaped potential surface. The ions slide to the center of the bottom of a focussing potential valley (2 or 3-dimensions), but slide off of the top of a hill-shaped surface, and hit the wall of an electrode. This is the reason for the existence, in the cylindrical geometry FAIMS, of the independent “modes” called 1 and 2. Such a FAIMS instrument is operated in one of four possible modes: P1, P2, N1, and N2. The “P” and “N” describe the ion polarity, positive (P) and negative (N). The waveform with positive DV, where DV describes the peak voltage of the high voltage portion of the asymmetric waveform, yields spectra of type P1 and N2, whereas the reversed polarity negative DV, waveform yields P2 and N1. The discussion thus far has considered positive ions but, in general, the same principles apply to negative ions equally.

A further improvement to the cylindrical FAIMS design is realized by providing a curved surface terminus of the inner electrode. The curved surface terminus is continuous with the cylindrical shape of the inner electrode and is aligned co-axially with an ion-outlet orifice of the FAIMS analyzer region. The application of an asymmetric waveform to the inner electrode results in the normal ion-focussing behavior described above, except that the ion-focussing action extends around the generally spherically shaped terminus of the inner electrode. This means that the selectively transmitted ions cannot escape from the region around the terminus of the inner electrode. This only occurs if the voltages applied to the inner electrode are the appropriate combination of CV and DV as described in the discussion above relating to 2-dimensional focussing. If the CV and DV are suitable for the focussing of an ion in the FAIMS analyzer region, and the physical geometry of the inner surface of the outer electrode does not disturb this balance, the ions will collect within a three-dimensional region of space near the terminus. Several contradictory forces are acting on the ions in this region near the terminus of the inner electrode. The force of the carrier gas flow tends to influence the ion cloud to travel towards the ion-outlet orifice, which advantageously also prevents the trapped ions from migrating in a reverse direction, back towards the ionization source. Additionally, the ions that get too close to the inner electrode are pushed back away from the inner electrode, and those near the outer electrode migrate back towards the inner electrode, due to the focusing action of the applied electric fields. When all forces acting upon the ions are balanced, the ions are effectively captured in every direction, either by forces of the flowing gas, or by the focussing effect of the electric fields of the FAIMS mechanism. This is an example of a three-dimensional atmospheric pressure ion trap, as disclosed in a copending PCT application in the name of R. Guevremont and R. Purves, the contents of which are herein incorporated by reference.

Ion focusing and ion trapping requires electric fields that are other than constant in space, normally occurring in a geometrical configuration of FAIMS in which the electrodes are curved, and/or are not parallel to each other. For example, a non-constant in space electric field is created using electrodes that are cylinders or a part thereof; electrodes that are spheres or a part thereof; electrodes that are elliptical spheres or a part thereof; and, electrodes that are conical or a part thereof. Optionally, various combinations of these electrode shapes are used.

As discussed above, one previous limitation of the cylindrical FAIMS technology is that the identity of the peaks appearing in the CV spectra are not unambiguously confirmed due to the unpredictable changes in Kₕ at high electric field strengths. Thus, one way to extend the capability of instruments based on the FAIMS concept is to provide a way to determine the make-up of the CV spectra more accurately, such as by introducing ions from the FAIMS device into a mass spectrometer for mass-to-charge (m/z) analysis. Advantageously, the ion focusing property of cylindrical FAIMS devices acts to enhance the efficiency for transporting ions from the analyzer region of a FAIMS device into an external sampling orifice, for instance an inlet of a mass spectrometer. This improved efficiency of transporting ions into the inlet of the mass spectrometer is optionally maximized by using a 3-dimensional trapping version of FAIMS operated in nearly trapping conditions. Under near-trapping conditions, the ions that have accumulated in the three-dimensional region of space near the spherical terminus of the inner electrode are caused to leak from this region, being pulled by a flow of gas towards the ion-outlet orifice. The ions that leak out from this region do so as a narrow, approximately collimated beam, which is pulled by the gas flow through the ion-outlet orifice and into a small orifice leading into the vacuum system of a mass spectrometer.

Additionally, the resolution of a FAIMS device is defined in terms of the extent to which ions having similar mobility properties as a function of electric field strength are separated under a set of predetermined operating conditions. Thus, a high-resolution FAIMS device transmits selectively a relatively small range of different ion species having similar mobility properties, whereas a low-resolution FAIMS device transmits selectively a relatively large range of different ion species having similar mobility properties. The resolution of FAIMS in a cylindrical geometry FAIMS is compromised relative to the resolution in a parallel plate geometry FAIMS because the cylindrical geometry FAIMS has the capability of focusing ions. This focusing action means that ions of a wider range of mobility characteristics are simultaneously focused in the analyzer region of the cylindrical geometry FAIMS. A cylindrical geometry FAIMS with narrow electrodes has the strongest focusing action, but the lowest resolution for separation of ions. As the radii of curvature are increased, the focusing action becomes weaker, and the ability of FAIMS to simultaneously focus ions of similar high-field mobility characteristics is similarly decreased. This means that the resolution of FAIMS increases as the radii of the electrodes are increased, with parallel plate geometry FAIMS having the maximum attainable resolution.

Note that, while the above discussion refers to the ions as being “captured” or “trapped”, in fact, the ions are subject to continuous ‘diffusion’. Diffusion always acts contrary to focussing and trapping. The ions always require an electrical, or gas flow force to reverse the process of diffusion. Thus, although the ions are focused into an imaginary cylindrical zone in space with almost zero thickness, or within a 3-dimensional ion trap, in reality it is well known that the ions are actually dispersed in the vicinity of this idealized zone in space because of diffusion. This is important, and should be recognized as a global feature superimposed upon all of the ion motions discussed in this disclosure. This means that, for example, a 3-dimensional ion trap actually has real spatial width, and ions continuously leak from the 3-dimensional ion trap, for several physical, and chemical reasons. Of course, the ions occupy a smaller physical region of space if the trapping potential well is deeper.

The need for rapid screening and detection of compounds in complex mixtures is increasing. This is particularly true of emerging applications in the biochemical and pharmaceutical fields. These applications demand a high degree of specificity in separations, and require systems that avoid slow separations. Prior art systems are known wherein compounds in complex mixtures are separated and analyzed by chromatographic or electrophoretic methods, combined with electrospray ionization and mass spectrometry for identification. Unfortunately, when using chromatographic or electrophoretic separation, only a small amount of sample is introduced at one time, as a discrete pulse. The components in the sample are then separated either through component-specific interaction with mobile or stationary phases, or by differences in the drift velocities of components under the influence of electric fields.

Unfortunately, it is a limitation of the prior art chromatographic and electrophoretic methods that a significant length of time is required in order to achieve a satisfactory separation, often on the order of minutes. This is due mainly to the typically slow speed at which the components of a mixture are transported through a dense medium, such as a liquid-state stationary phase. In contrast, mass spectrometric methods, in which ions are studied in the gaseous phase, provide data almost immediately after a sample is introduced. Consequently, there is a significant time during which the mass spectrometric instrumentation is idly waiting for the arrival of transient signals. It is a further limitation of the prior art methods that ionization of the compounds occurs subsequent to the separation step, such that a relatively high proportion of the ions that are introduced into the mass spectrometer are artifacts of the ionization source and are other than of interest. As a result, the detection limits for the analyte ions are increased.

It would be advantageous to provide an alternate way to rapidly separate components from very complex mixtures, such that the lengthy time delays that are introduced by chromatographic or electrophoretic methods are significantly reduced or eliminated. It would be further advantageous to provide an apparatus and a method for separating ions derived from said components for introduction directly into a mass spectrometer for identification. Ion formation before separation is advantageous because the ions in the gas phase are easily accelerated through an analyzer region under the influence of applied electric fields, allowing rapid and highly selective separations to be achieved.

### OBJECT OF THE INVENTION

In order to overcome these and other limitations of the prior art, it is an object of the present invention to provide an apparatus for separating ions in which a two separate ion separations are performed in tandem to increase the overall resolution of the separation process relative to resolution achieved with only one of the separation alone.

In order to overcome these and other limitations of the prior art, it is an object of the present invention to provide an apparatus for separating ions in which a first separation is performed under conditions that are improved for performing the first separation and a second separation is performed, in tandem with the first separation, under conditions that are improved for performing the second separation.

### SUMMARY OF THE INVENTION

In accordance with the invention there is provided a1. A method for separating ions, comprising the steps of:

a) providing a first analyzer region defined by a space between first and second spaced apart electrodes, the first analyzer region in communication with a first ion inlet and a first ion outlet, the first ion inlet for receiving ions for introduction into the first analyzer region, the first ion outlet for providing ions from the first analyzer region;

b) providing a second analyzer region in operational communication with the first analyzer region, the second analyzer region in communication with a second ion inlet and a second ion outlet, the second ion inlet for receiving ions for introduction into the second analyzer region, and the second ion outlet for providing ions from the second analyzer region;

c) providing ions to one of the first analyzer region and the second analyzer region;

d) coupling ions from the ion outlet of the one of the first and second analyzer regions to the ion inlet of the other of the first and second analyzer regions;

e) providing a first asymmetric waveform and a first direct-current compensation voltage, to at least one of the first and second electrodes, to form an electric field therebetween, the first asymmetric waveform for effecting a difference in net displacement between two different ions in the time of one cycle of the applied first asymmetric waveform;

f) setting the first compensation voltage for effecting a first separation of the ions to support selective transmission of a first subset of the ions within the first analyzer region; and,

g) providing conditions within the second analyzer region for effecting a second separation of ions therein to support selective transmission of a second subset of the ions within the second analyzer region,

wherein one of the first and second subsets of ions is a subset of the other.

In accordance with another aspect of the invention there is provided an apparatus for separating ions, comprising:

a first analyzer comprising two spaced apart electrodes defining a first analyzer region therebetween, the first analyzer region having a first ion inlet for receiving ions for introduction into the first analyzer region and a first ion outlet for providing ions from the first analyzer region;

a second analyzer in fluid communication with the first analyzer, the second analyzer comprising a second ion inlet for receiving ions for introduction into the second analyzer region, a second ion outlet for providing ions from the second analyzer region and two spaced apart electrodes defining a second analyzer region therebetween and in communication with the second ion inlet and the second ion outlet;

an ionization source for providing ions to one of the first analyzer region and the second analyzer region;

wherein the first and second analyzers are disposed for coupling ions from one of the first and second analyzer regions to the other of the first and second analyzer regions; a first voltage source for providing a first asymmetric waveform and a first direct-current compensation voltage to at least one of the two spaced apart electrodes of the first analyzer, to form a first electric field therebetween, the first asymmetric waveform for, in use, effecting a difference in net displacement between the ions in the time of one cycle of the applied first asymmetric waveform and the first compensation voltage for, in use, effecting a first separation of the ions by supporting selective transmission of a first subset of the ions within the first analyzer region; and, a second voltage source for providing at least a voltage to at least one of the two spaced apart electrodes of the second analyzer, to form an electric field therebetween, the electric field for effecting a second different separation of the ions to support selective transmission of a second subset of ions within the second analyzer region, wherein one of the first and second subsets of ions is a subset of the other.

### BRIEF DESCRIPTION OF THE DRAWINGS

FIG. 1 shows three possible examples of changes in ion mobility as a function of the strength of an electric field;

FIG. 2a illustrates the trajectory of an ion between two parallel plate electrodes under the influence of the electrical potential V(t);

FIG. 2b shows an asymmetric waveform described by V(t);

FIG. 3 shows a simplified block diagram of a generalized system for separation of ions with mass spectrometric detection;

FIG. 4 shows a schematic diagram of a tandem FAIMS device with mass spectrometric detection according to a first preferred embodiment of the present invention;

FIG. 5a shows a cross sectional view of a tandem FAIMS device with electrometer ion detection according to the first preferred embodiment of the present invention;

FIG. 5b shows a cross sectional view of a tandem FAIMS device according to a second preferred embodiment of the present invention;

FIG. 6 shows a schematic diagram of a transverse gas flow ion mobility spectrometer;

FIG. 7 shows the transverse gas flow ion mobility spectrometer of FIG. 6 being used in tandem combination with FAIMS according to a third preferred embodiment of the present invention;

FIG. 8 shows a schematic diagram of a drift tube ion mobility spectrometer being used in tandem combination with FAIMS according to a fourth preferred embodiment of the present invention;

FIG. 9 shows a schematic diagram of a drift tube ion mobility spectrometer being used in a different tandem combination with FAIMS according to a fifth preferred embodiment of the present invention;

FIG. 10 shows a schematic diagram of a drift tube ion mobility spectrometer being used in a different tandem combination with FAIMS according to a sixth preferred embodiment of the present invention;

FIG. 11a shows a schematic diagram of a drift tube ion mobility spectrometer being used in a different tandem combination with FAIMS according to a seventh preferred embodiment of the present invention;

FIG. 11b shows a schematic diagram of a segmented quadrupole rod assembly in side view;

FIG. 11c shows a schematic diagram of a radio-frequency only quadrupole device comprising a set of rod segments, one segment from each of four different quadrupole rod assemblies;

FIG. 11d shows a schematic diagram of an end-view of the radio-frequency only quadrupole device that was shown in FIG. 11c with simplified electrical connections thereto; and,

FIG. 12 shows a schematic diagram of a drift tube ion mobility spectrometer being used in a different tandem combination with FAIMS according to an eighth preferred embodiment of the present invention.

### DETAILED DESCRIPTION OF THE INVENTION

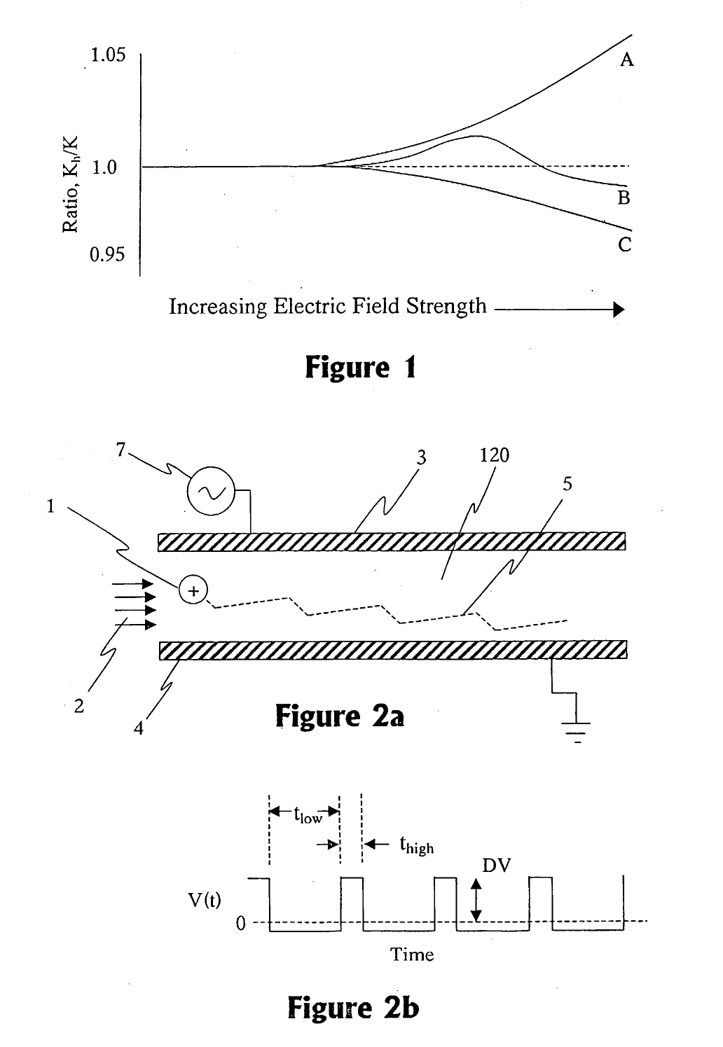

Referring to FIG. 1, shown are three possible examples of the change in ion mobility properties with increasing electric field strength, as was discussed previously. The separation of ions in FAIMS is based upon a difference in these mobility properties for a first ion relative to a second ion. For instance, a first type A ion having a low field mobility K_{1,low} is other than separated in a FAIMS device from a second type A ion having a second different low field mobility K_{2,low}, if under the influence of high electric field strength, the ratio K_{1,high}/K_{1,low} is equal to the ratio K_{2,high}/K_{2,low}. Interestingly, however, this same separation is achieved using conventional ion mobility spectrometry, which is based on a difference in ion mobilities at low applied electric field strength.

Referring to FIG. 2a, shown is a schematic diagram illustrating the mechanism of ion separation according to the FAIMS principle. An ion 1, for instance a positively charged type A ion, is carried by a gas stream 2 flowing between two spaced apart parallel plate electrodes 3 and 4. One of the plates 4 is maintained at ground potential, while the other plate 3 has an asymmetric waveform described by V(t), applied to it. The peak voltage applied during the waveform is called the dispersion voltage (DV), as is shown in FIG. 2b. Referring still to FIG. 2b, the waveform is synthesized so that the electric fields during the two periods of time t_{high} and t_{low} are not equal. If Kₕ and K are identical at high and low fields, the ion 1 is returned to its original position at the end of one cycle of the waveform. However, under conditions of sufficiently high electric fields, Kₕ is greater than K and the distances traveled during t_{high} and t_{low} are no longer identical. Within an analyzer region defined by a space 120 between the first and second spaced apart electrode plates, 3 and 4, respectively, the ion 1 experiences a net displacement from its original position relative to the plates 3 and 4 as illustrated by the dashed line 5 in FIG. 2a.

If a type A ion is migrating away from the upper plate 3, a constant negative dc compensation voltage CV is applied to plate 3 to reverse or “compensate” for this offset drift. Thus, the ion 1 does not travel toward either plate. If two species of ions respond differently to the applied high electric field, for instance the ratios of Kₕ to K are not identical, the compensation voltages necessary to prevent their drift toward either plate are similarly different. To analyze a mixture of ions, the compensation voltage is, for example, scanned to transmit each of the components of a mixture in turn. This produces a compensation voltage spectrum, or CV spectrum.

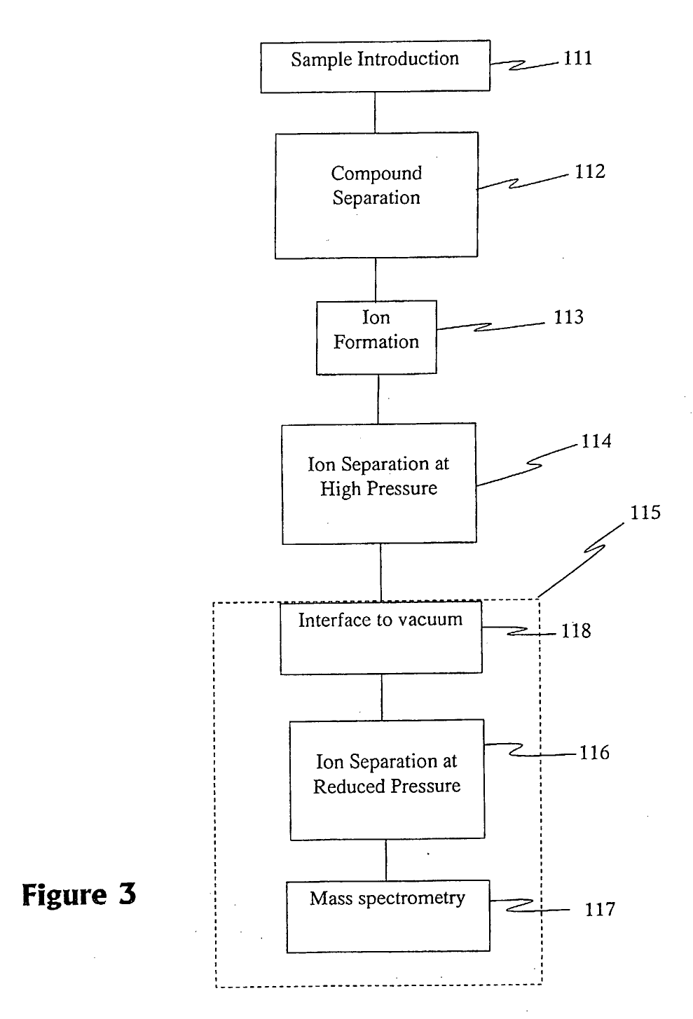

Referring to FIG. 3, shown is a generalized concept of an analytical device composed of a sample introduction 111, compound separations 112, ion formation at atmospheric pressure 113, ion separation at atmospheric pressure 114, ion transferred into a low pressure region 115, ion separation at low pressure 116, and mass analysis by mass spectrometry 117. All of the low pressure components are generally sealed within a chamber and a small orifice located in the interface to the vacuum 118 allows a limited flow of high pressure gas to flow into the low pressure region 115. Those components within the low pressure region 115 are not as readily manipulated in the laboratory as the components which operate at atmospheric pressure. In the present disclosure, a new apparatus and method of ion separation, suitable for use in the generalized system shown in FIG. 3, is presented.

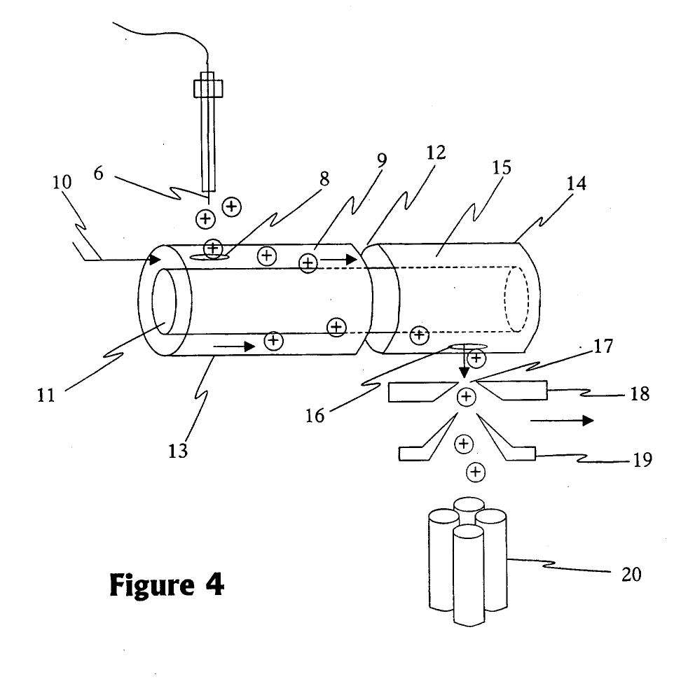

Referring to FIG. 4, shown is a schematic diagram of a tandem FAIMS device with mass spectrometric detection according to a first preferred embodiment of the present invention. The ions are generated using a corona discharge needle 6. Of course, any other suitable ionization source, such as for instance an electrospray ionization source, is used optionally in place of the corona discharge ion source. The corona is established at the tip of the needle 6 by application of a high voltage, the high voltage power supply is not shown. The ions that are generated by the corona discharge move across the gap between the needle 6 and an orifice 8 leading into FAIMS under the influence of the electric field generated by the high voltage applied to the needle 6. The ions are carried along the length of FAIMS in an analyzer region 9 by a carrier gas flow 10. Ions are separated in the analyzer region 9 because of the motion of the ions within this analyzer region induced by application of an asymmetric waveform and a dc compensation voltage to the inner FAIMS electrode 11. Only a subset of the original ions, for instance those ions having appropriate mobility properties, are selectively transmitted through the analyzer region 9 and reach the gap 12 between the FAIMS outer electrodes 13 and 14. Although not shown in FIG. 4, a gas flow optionally occurs into FAIMS or out of FAIMS at the gap 12. Optionally the FAIMS outer electrodes 13 and 14 are held at different electrical voltages, which effectively corresponds to application of different compensation voltages to the FAIMS defined by the outer electrodes 13 and 14, and therefore different electric field conditions in the analyzer region 9 between electrode 11 and electrode 13 and the analyzer region 15 between electrode 11 and electrode 14. Those ions that reach gap 12 are carried into the analyzer region 15 in which the electric fields are optionally different than the electric fields in analyzer region 9. Only a portion of the ions that reach gap 12 also have appropriate mobility properties to pass through analyzer region 15.

Still referring to FIG. 4, those ions having appropriate mobility properties to pass through analyzer region 15 are directed through an orifice 16 in the second FAIMS outer electrode 14, and are further directed through an orifice 17 in an orifice plate 18. The ions pass through a skimmer cone 19 and are analyzed within a mass spectrometer 20, for instance a quadrupole mass filter, as shown in FIG. 4.

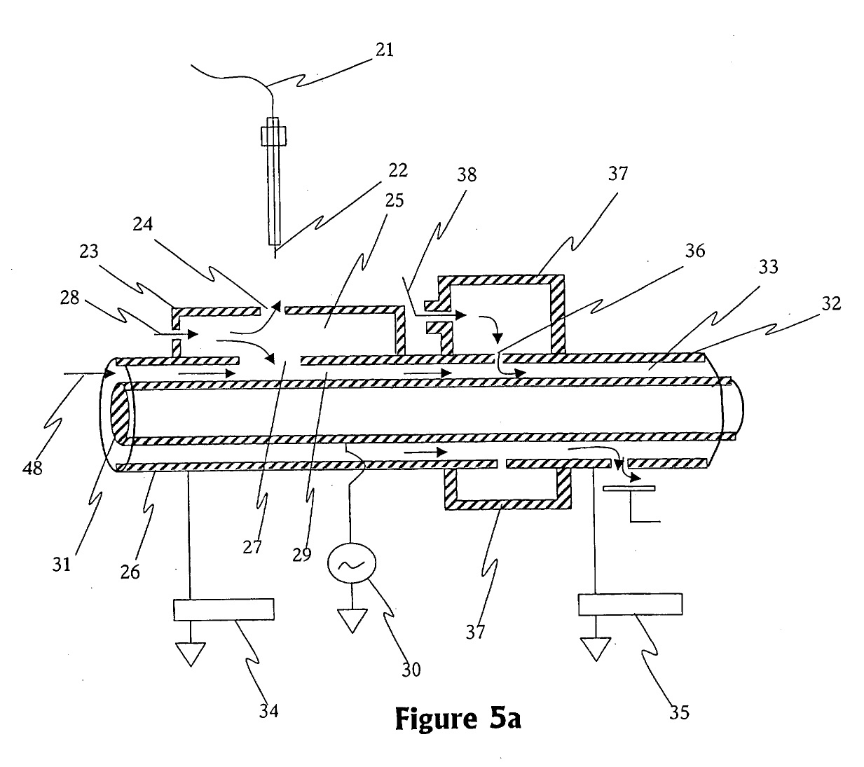

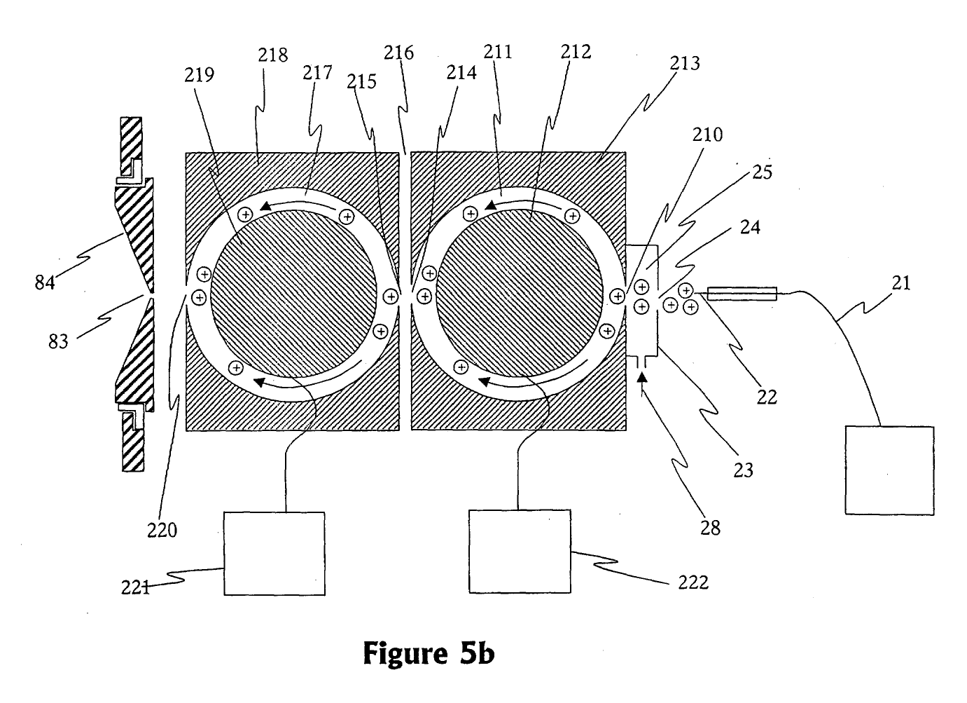

Referring to FIG. 5a, shown is a cross sectional view of a tandem FAIMS device with electrometer detection according to the first preferred embodiment of the present invention. Ions are formed, for example using an electrospray ionization ion source composed of a liquid delivery capillary 21 and a fine-tipped electrospray needle 22 that is held at high voltage (power supply not shown). Of course, any other suitable ionization source is used optionally in place of the electrospray ionization ion source. The ions pass to FAIMS through a curtain gas assembly composed of a curtain plate 23 with orifice 24, a gap 25 between the curtain plate 23 and the outer electrode 26 of FAIMS, and into an orifice 27 in the outer FAIMS electrode 26. A curtain gas 28 enters the gap 25, and escapes in part out through the orifice 24 in the curtain plate 23, and in part travels into the FAIMS analyzer region 29 through orifice 27. An asymmetric waveform and a dc compensation voltage is generated by power supply 30 and is applied to the inner cylindrical FAIMS electrode 31 which passes through the central longitudinal axis of the outer FAIMS electrodes 26 and 32. The fields generated by the voltages applied to the electrode 31 are responsible for the ion separation and ion focusing that takes place in the analyzer regions 29 and 33. The outer FAIMS electrodes 26 and 32 are held at dc voltages by independent power supplies 34 and 35, respectively. Therefore, the dc electric field between the cylindrical inner electrode 31 and the outer electrode 26 is optionally different from the dc electric field between the cylindrical inner electrode 31 and the outer electrode 32.

Still referring to FIG. 5a, the gap 36 between the outer FAIMS electrodes 26 and 32 is optionally enclosed in a chamber 37 which is supplied by a gas 38. This gas 38 supplied to the chamber 37 is added to the flow of carrier gas 48 which is transporting the ions along the analyzer region 33. This gas is supplied to prevent ions from exiting FAIMS through the gap 36, and is optionally supplied to change the carrier gas chemical composition to improve the ion separation or ion selection specificity of the FAIMS system.

In the devices shown in FIGS. 4 and 5a the gaps 12 and 36, respectively, between the external cylinders permits two different voltages to be applied to the individual external cylinders 13 and 14, or 26 and 32, respectively. Since the focusing of a given ion in FAIMS is a balanced condition of dispersion voltage (DV) and compensation voltage (CV), it is expected that a given ion is transported through the entire device if the external cylinders are the same voltage. New experiments can be carried out if the external cylinders are held at different voltages. If the ions are undergoing a change in property, for example a decrease in solvation, then after transport part of the way through FAIMS, the ions are focused optimally under slightly different conditions. In this case, the efficiency of transport of slowly changing ions is improved. A second possible benefit of the split external cylinders is that the linear gas flow rate in the second half of the device is optionally increased or decreased relative to that in the first half of the device. This is a significant advantage if the gas flows for sample introduction and for ion detection are not similar. In this case the device is tandem, meaning that it behaves as two independent FAIMS units, one at the front and one at the detector end.

The combination of CV and DV that is necessary for optimum transmission of an ion is a function of the composition of the carrier gas. For example, as disclosed in a copending PCT application in the name of R. Guevremont, R. Purves and D. Barnett, for many small, positively charged ions that are transmitted through FAIMS, the CV necessary for transmission is higher with oxygen as a carrier gas than with nitrogen as a carrier gas. Further, it is disclosed that a controlled addition of a second gas, for example carbon dioxide, to the carrier gas will, for some ions, change the CV necessary for ion transmission. The tandem arrangement of FAIMS takes maximum advantage of these changes in CV. For example, if an ion is transmitted through the first analyzer region 29 in FIG. 5a, with an applied CV of 10 volts using nitrogen as a carrier gas, this same ion may then be transmitted through analyzer region 33 with an applied CV of 15 volts and a carrier gas that is 90% nitrogen and 10% carbon dioxide. The carbon dioxide is added to the carrier gas through gap 36. This seems like an unnecessary complication because the ion would have completely traversed the FAIMS if the CV was held constant and only nitrogen used as a carrier gas. This added complication is understood if two very similar ions are simultaneously transmitted at the same CV with only nitrogen as the carrier gas, but transmitted at different CV when the gas is 90% nitrogen and 10% carbon dioxide. Although these two hypothetical ions cannot be separated in analyzer region 29 in FIG. 5a, they are be separated in region 33 if carbon dioxide is added through gap 36, and the CV is adjusted using the voltage applied to the outer electrode 32 using power supply 35. Of course, an ion of interest is separated from a more complex mixture in a similar manner. For example, a mixture including three different species of ions, w, x and y, wherein ion x is separated from ion w and from ion y in pure nitrogen, and ion w is separated from ion x and from ion y in a mixture of nitrogen and carbon dioxide, is to be separated. If the ion of interest is ion y, then it is other than possible to separate the desired ion from the mixture of ions using either one of these two compositions of gas alone, for example using a prior art FAIMS device. Advantageously, when the ion mixture is directed through each one of the two gas compositions, for example within a tandem arrangement of FAIMS analyzer regions, then in a first analyzer region ion x is selectively rejected, and in a second analyzer region ion w is further rejected, such that ion y alone is selectively transmitted within the second analyzer region. FAIMS is inherently a low resolution ion separation apparatus, such that the tandem arrangement shown in FIGS. 4 and 5a serve to increase the specificity of ion selection and hence indirectly improves the resolution of FAIMS.

Referring now to FIG. 5b, shown is a tandem FAIMS based upon perpendicular gas flow FAIMS (pFAIMS-pFAIMS), according to a second preferred embodiment of the present invention. Ions are formed, for example using an electrospray ionization ion source composed of a liquid delivery capillary 21 and a fine-tipped electrospray needle 22 that is held at high voltage (power supply not shown). Of course, any other suitable ionization source is used optionally in place of the electrospray ionization ion source. The ions pass to pFAIMS through a curtain gas assembly composed of a curtain plate 23 with orifice 24, a gap 25 between the curtain plate 23 and the outer electrode 213 of FAIMS, and into an orifice 210 in the outer FAIMS electrode 213. A curtain gas 28 enters the gap 25, and escapes in part out through the orifice 24 in the curtain plate 23, and in part travels into the FAIMS analyzer region 211 through orifice 210. The ions enter the first pFAIMS through orifice 210 and are separated as they are carried by a flow of gas along the analyzer region 211. The analyzer region 211 is an annular space between a cylindrical inner FAIMS electrode 212 and the outer FAIMS electrode 213. The asymmetric waveform and the compensation voltage are applied to the inner FAIMS electrode 212. The outer FAIMS electrode 213 is maintained at a dc voltage by a power supply (not shown). The ions that pass through the analyzer region 211 are carried by gas flow and electric fields out of the orifice 214 of the first pFAIMS and into the orifice 215 of the second pFAIMS. The orifice 214 and 215 may be combined if there is no need for an extra gas flow in the gap 216 between the two FAIMS devices. A gas flow through gap 216 is optionally provided to add a new type of gas to the carrier gas which will enter the second pFAIMS through orifice 215. Flows in the gap 216 are optionally inward or outward, or across the gap between orifice 214 and 215. Those ions that enter orifice 215 into the second pFAIMS will be carried by a gas flow along analyzer region 217, which is between the outer FAIMS electrode 218 and the inner cylindrical FAIMS electrode 219. The asymmetric waveform and the compensation voltage are applied to the inner electrode 219. If the conditions of the electric field are appropriate for transmission of the ion through the analyzer region 217, the ion will exit the second pFAIMS at orifice 220 and enter the orifice 84 in orifice plate 84 leading to the differentially pumped region of a mass spectrometer (not shown).

The tandem FAIMS shown in FIG. 5b is optionally very compact, since the inner electrodes 212 and 219 are mounted perpendicular to the front face of the orifice plate 84. If the inner electrodes 212 and 219 are approximately 15 mm diameter, the total distance between the inlet orifice 210 and the orifice 83 leading into the vacuum system is approximately 38 mm, assuming the analyzer regions 211 and 217 are approximately 2 mm wide. The tandem FAIMS design that is disclosed with reference to FIG. 5b is convenient to use because the ions travelling into orifice 210 are moving in a direction aligned with the direction of travel of the ions leaving orifice 83 in orifice plate 84. OF course, the gap 216 between the external cylinders 213 and 218 optionally allows two different voltages to be applied to the individual external cylinders 213 and 218.

The tandem FAIMS devices described with reference to FIGS. 4, 5a and 5b are, in a most generic sense, tandem ion mobility spectrometers (tandem IMS). An advantage of a tandem IMS device is that a first ion separation is performed in a first analyzer region and a second different ion separation is performed under different experimental conditions in a second analyzer region. In the preferred embodiments of the present invention described previously, the first and the second different ion separation steps are based on a same principle, each one being optionally performed under different operating conditions. Alternatively, a tandem IMS could be devised wherein the first ion separation is based upon a first principle, for instance FAIMS, and the second different ion separation is based upon a second different principle, for instance the ion mobility properties at low electric field strength. Two techniques that are based on differences in ion mobility properties at low electric field strength are transverse gas flow ion mobility spectrometry (TGFIMS) and drift tube ion mobility spectrometry (DTIMS). As was previously discussed with reference to FIG. 1, a first type A ion having a low field mobility K_{1,low} is not separated in a FAIMS device from a second type A ion having a second different low field mobility K_{2,low}, if under the influence of high electric field strength, the ratio K_{1,high}/K_{1,low} is equal to the ratio K_{2,high}/K_{2,low}. However, this same separation is achieved using TGFIMS or DTIMS, which are based on a difference in ion mobility properties at low applied electric field strength.

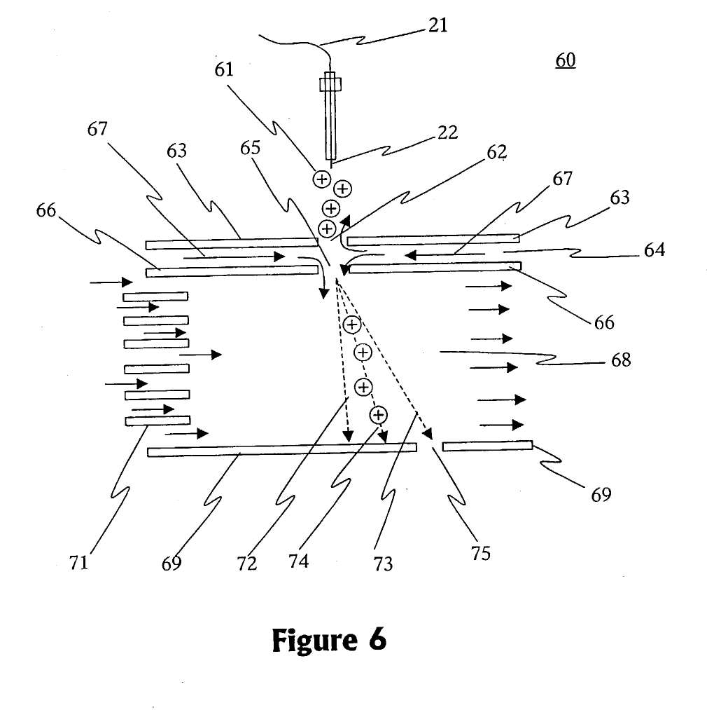

Referring to FIG. 6, shown is a TGFIMS system generally indicated by reference numeral 60. Ions are formed, for example using an electrospray ionization source composed of a liquid delivery capillary 21 and a fine-tipped electrospray needle 22 that is held at high voltage (power supply not shown). Of course, any other suitable ionization source is used optionally in place of the electrospray ionization source. As the liquid is pumped through the capillary 21, it emerges from the tip 22 as a very fine spray composed of liquid drops, liquid vapor and ions. Only the ions 61 are shown in FIG. 6. In known manner, a curtain gas assembly is used to prevent vapor and droplets from entering the TGFIMS as explained below. The ions move through a curtain gas orifice 62 in curtain plate 63 and across a gap 64. The ions then pass through a top plate orifice 65 in the top plate 66 of TGFIMS 60. A portion of the inlet curtain gas 67 flows outward through the curtain gas orifice 62 in curtain plate 63, and another portion flows inward through the top plate orifice 65 to TGFIMS 60 to assist in carrying the ions into TGFIMS 60. This splitting of the curtain gas 67 prevents liquid vapors and droplets from entering TGFIMS 60. The ions are moved across the gap 64 by an electric field generated by a voltage difference applied between the curtain plate 63 and the top plate 66 of TGFIMS 60.

Still referring to FIG. 6, TGFIMS 60 separates ions during their traverse of the gap 68 between the top plate 66 and the lower plate 69 of TGFIMS 60. The ions are directed across the gap 68 by a voltage difference that is applied between plates 66 and 69. A TGFIMS carrier gas flow 76 is admitted to the gap 68 between electrodes 66 and 69 in a direction that is approximately perpendicular to the direction of the applied electric field. Means for removal of gas flow turbulence, shown as a series of parallel plates 71 in FIG. 6, are optionally provided. The carrier gas flow 76 carries the ions with a velocity component that is approximately parallel to the plates 66 and 69 as the ions traverse the gap 68 under the influence of the applied electric field. A bottom plate orifice 75 in the lower plate 69 serves to carry selected ions out of TGFIMS 60.

Still referring to FIG. 6, three examples of ion paths are shown at dotted lines 72, 73 and 74. Path 72 represents the motion of an ion with high mobility that moves rapidly across gap 68 and therefore is carried a short distance downstream by the flow of gas 76. Path 73 represent the motion of a second ion with low mobility, which is carried much further downstream, because the time required by this ion to travel across the gap 68 is longer than for the ion that follows path 72. Finally, the path 74 of a third ion falls somewhere between the paths 72 and 73. These paths 72, 73 and 74 carry the ions to various locations on the lower plate 69. Only those ions having a trajectory that passes through the bottom plate orifice 75 are transmitted out of the TGFIMS 60. The location at which the ion strikes the bottom plate 69 is dependent upon parameters including the mobility of the ion, the flow rate of the TGFIMS carrier gas 76, the voltage difference between plates 66 and 69, and the distance between plates 66 and 69. The narrowness or specificity of the location that the ion strikes plate 69 is dependent on the extent to which the ions spread physically during transit across the gap 68. This depends upon parameters including: the time of transit of the ion across the gap 68, the turbulence of the flow of gas 76, the mobility of the ions in the particular type of gas 76, and the space charge ion-ion repulsion.

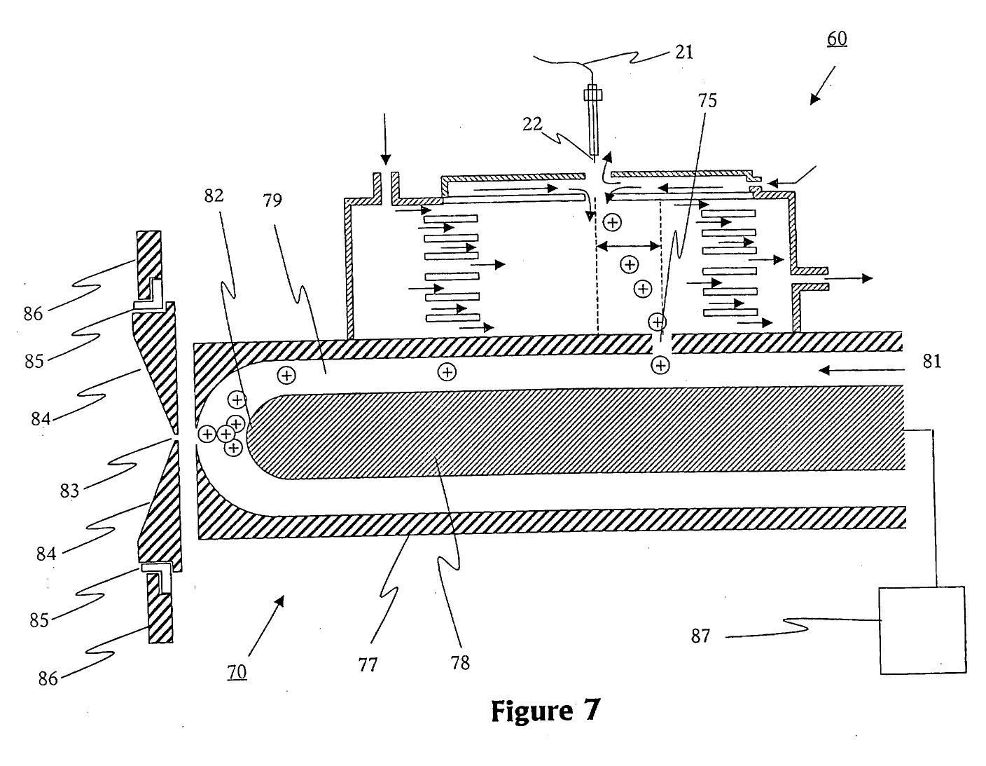

Referring to FIG. 7, a third preferred embodiment of the present invention is shown. The TGFIMS 60 described previously with reference to FIG. 6 is shown in tandem combination with a FAIMS device generally refereed to by reference numeral 70. The FAIMS 70 is composed of an outer cylinder 77, one side of which optionally corresponds to the lower plate 69 of TGFIMS 60 shown in FIG. 6, and an inner FAIMS electrode 78. The bottom plate orifice 75 permits ions to pass out of TGFIMS 60 and into the analyzer region 79 of FAIMS 70. Electrode 78 is powered by a power supply 87, which provides an asymmetric waveform and a dc compensation voltage superimposed on the waveform as discussed earlier with reference to FIG. 2. A supply of FAIMS carrier gas 81 flows along the annular analyzer region 79 between the outer electrode 77 and the inner electrode 78. The inner electrode 78 is cylindrical, with a curved dome 82 at its terminus. The ions flow to this terminus while focused in the analyzer region 79. The ions which are able to travel to the curved dome 82 are then moved inwardly towards the central axis of the inner electrode 78, and under near trapping conditions are carried by the FAIMS carrier gas flow 81 into an orifice 83, in the center of orifice plate 84, leading to the vacuum of a mass spectrometer (not shown). The ion focussing and three-dimensional atmospheric pressure ion trapping properties of cylindrical FAIMS having a domed terminus is disclosed in a copending PCT application in the name of R. Guevremont, and R. Purves, the contents of which are herein incorporated by reference.

Also shown in FIG. 7 is an orifice plate 84 that is mounted on an electrically isolating ring 85, which is in turn mounted into the outer wall 86 of the vacuum chamber of a mass spectrometer. The electrical isolation of the orifice plate 84 permits voltage differences to be applied between FAIMS 70 and the orifice plate 84, and between the orifice plate 84 and other components (not shown) in the interface leading into the mass spectrometer.

As described previously, ions are separated in FAIMS 70 on the basis of the difference in the mobility of an ion at high electric field strength, Kₕ, relative to its mobility at low electric field strength, K. On the other hand, TGFIMS 60 separates ions on the basis of their mobility through a gas in a constant electric field. Advantageously, TGFIMS 60 is used in tandem with FAIMS 70 to separate ions with improved resolution compared to the results that are obtainable using FAIMS 70 alone or TGFIMS 60 alone.

The tandem combination of TGFIMS 60 and FAIMS 70 is particularly advantageous since both are operable in a continuous mode. Thus, a sample mixture is continuously delivered to the inlet of the TGFIMS 60, and a selected component is continuously passed through the outlet of the TGFIMS 60 into the inlet of FAIMS 70. In turn, the FAIMS 70 is electronically controlled to further select the desired components that are allowed to pass through the FAIMS 70. The tandem combination of TGFIMS 60 and FAIMS 70 is particularly suitable for delivering desired sample ions to a mass spectrometer for further processing and analysis. Since both the TGFIMS 60 and FAIMS 70 are operable in continuous mode, the mass spectrometric instrumentation is allowed to make continuous measurements of selected components in the mixture. Optionally, the mass spectrometer is used to study a particular component continuously, until sufficient information is acquired. This is other than possible with existing chromatographic and electrophoretic techniques because the component of interest only arrives at the end of the separation as a transient pulse. This transient operation significantly limits the number, and types, of experiments that can be performed during the lifetime of a given transient. If the information acquired during the transient is insufficient, a new sample must be injected and a delay is encountered during which the components are separated. These problems with transient signals do not occur with the tandem combination of TGFIMS 60 and FAIMS 70, which together operate as a continuous flow-through ion separator.

The independence of these types of separations is very significant, since the tandem combination of TGFIMS 60 and FAIMS 70 allows ions to be selected in ways that were previously not possible for a continuous mode system. Of course, in an alternative embodiment of the present invention, the FAIMS apparatus is optionally placed before the TGFIMS. The selection of the order of these two devices is based on several considerations. The device which is most capable of handling high density of a mixture of ions should be placed first. The device that is least susceptible to contaminants, or neutrals originating from non-ionized components from the ionization process should be placed first. Since some time delays are incurred during switching between ions, the device that is switched less frequently should be placed fist. Gas flow rate compatibility between the ion source and the first ion separator might be a determining factor. Gas flow rate compatibility between the second ion separator and the detector, for instance a mass spectrometer, might also influence selection of the order of the tandem components FAIMS and TGFIMS.

In order to minimize the formation of cluster ions or hydrated ions between the ion of interest and contaminants or water in the carrier gas, it is anticipated that the TGFIMS is operated at elevated temperatures, for instance 200° C. Of course, this requires the thermal separation of TGFIMS from the electrospray ionization source, which cannot be operated at temperatures exceeding the boiling point of the solvents, and from FAIMS. FAIMS is optionally operated at the same temperature as TGFIMS. Of course, FAIMS and TGFIMS are optionally operated at lower or higher pressure than the ambient atmospheric pressure. As discussed previously, both FAIMS and TGFIMS represent various embodiments of the class of techniques that are generically referred to as ion mobility spectrometry, and therefore operate at gas pressures in which the ion reaches steady state velocity in response to constant, steady-in-time electric field. There is no upper limit to this pressure range, whereas the lower limit is probably below 1 Torr (1 mm Hg) pressure.

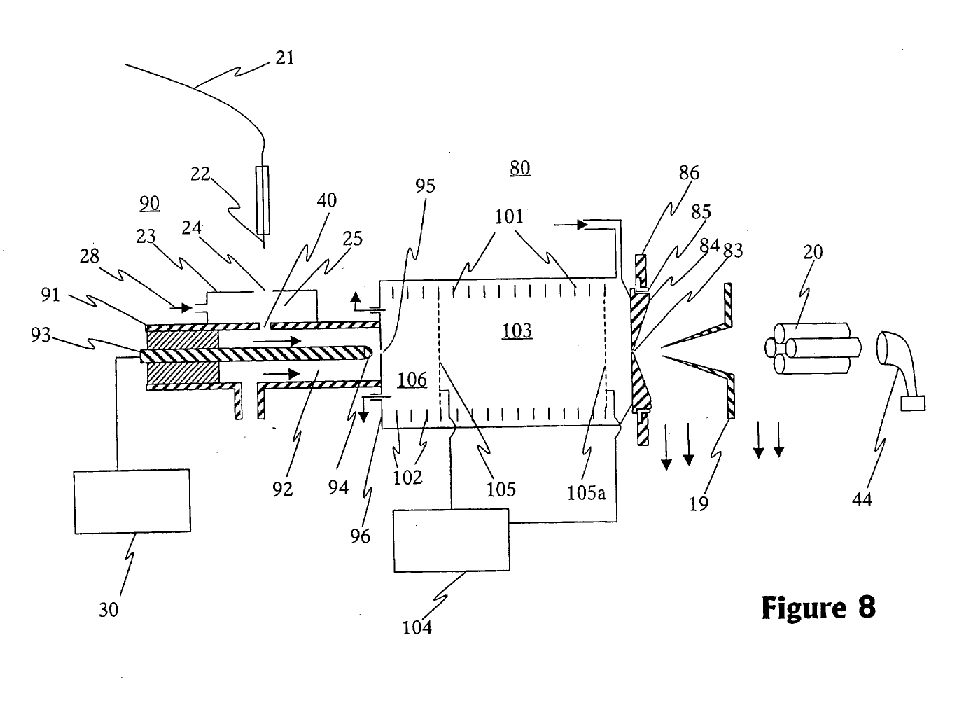

Referring to FIG. 8 a fourth preferred embodiment of the present invention, comprising a FAIMS portion capable of operating in a mode for trapping ions and indicated generally by reference numeral 90, and a DTIMS portion indicated generally by reference numeral 80, is shown. Ions are formed, for example using an electrospray ionization ion source composed of a liquid delivery capillary 21 and a fine-tipped electrospray needle 22 that is held at high voltage (power supply not shown). Of course, any other suitable ionization source used optionally in place of the electrospray ionization ion source. The ions pass to FAIMS 90 through a curtain gas assembly composed of a curtain plate 23 with orifice 24, a gap 25 between the curtain plate 23 and the outer electrode 91 of FAIMS, and into an orifice 40 in the outer FAIMS electrode 91. A curtain gas 28 enters the gap 25, and escapes in part out through the orifice 24 in the curtain plate 23, and in part travels into the FAIMS analyzer region 92 through orifice 40. An asymmetric waveform and a dc compensation voltage is generated by power supply 30 and is applied to the inner cylindrical FAIMS electrode 93 which passes through the central longitudinal axis of the outer FAIMS electrode 91, and which ends in a curved dome 94. The fields generated by the voltages applied to the electrode 93 are responsible for the ion separation and ion focusing that takes place in the analyzer region 92. The outer FAIMS electrode 91 is held at dc voltage by an independent power supply (not shown). Along most of the length of FAIMS the action of the electric fields is perpendicular to the transporting motion of the gas flow. However, near the vicinity of the curved dome 94, the gas flows and the electric fields are no longer perpendicular, but rather act in opposition to each other. Thus, by properly controlling the gas flow and the electric fields, desired ions which have a high field mobility suitable for transmission through the FAIMS 90 are accumulated near the central axis of the inner electrode near the vicinity of the curved dome 94. The ions are optionally extracted from within this trapping region, for example, by the application of at least an extraction voltage to ion-outlet electrode 96.

Still referring to FIG. 8, both the ion-trapping FAIMS 90 and the DTIMS 80 are operating at high pressure, for instance substantially atmospheric pressure. In FIG. 8, the DTIMS 80 is followed by an orifice 83 leading to the vacuum chamber of a mass spectrometer 20. As previously explained, the ions which have the high field mobility suitable for transmission through FAIMS 90 at the conditions of dispersion voltage and compensation voltage are trapped near the vicinity of the curved dome 94. The ions are extracted from this location as a pulse by a combination of electric and gas flow forces. Of course, optionally the voltages and gas flows are adjusted to provide near-tapping conditions such that the ions continuously leak from the trapping region as an approximately collimated beam of ions. The ions then pass out of FAIMS 90, through an orifice 95 in the ion-outlet electrode 96 of FAIMS 90, and to an entrance gate grid 105 in the DTIMS 80. A series of evenly spaced plates 102, to which a set of uniformly incremented voltages is applied, serve to pull the ions towards the gate grid 105 in the region between orifice 95 and the entrance gate grid 105. Of course, optionally a set of uniformly decremented voltages is applied to the series of evenly spaced plates 102, in dependence upon the polarity of the ion charge. An optimal region 106 serves to move the ions to an isothermal region inside DTIMS 80, and keeps the region near the entrance gate grid 105 as far as possible from the thermal region, and gas flow influences of the orifice 95. For simplicity, the temperature controls for these components are not shown. Additionally, the power supplies for the FAIMS curtain plate 23, and the FAIMS ion-outlet electrode 96, are not shown.

Still referring to FIG. 8, the ions which impinge upon the gate grid 105 of DTIMS are intermittently permitted to pass into the drift region 103 of DTIMS by temporarily opening entrance gate grid 105, using gate grid controller 104. Of course the timing of opening of the entrance gate grid 105 is synchronized with the arrival of the extracted ions from the ion-trapping FAIMS 90. The gas within the DTIMS 80 is at sufficient pressure so that the ions drift at a constant velocity while under the influence of a uniform, constant strength electric field. Typically, the electric field is generated using a set of parallel flat plates 101 within a drift region 103, each parallel plate of the set of parallel flat plate 101 having an aperture through which ions pass, and each of which is connected to a dc power supply (not shown). The plates 101 are aligned so that the ions drift down a channel that is created by the alignment of the apertures in each of the parallel plates. The voltages applied to the individual plates are adjusted so that a uniform constant strength field is generated between the plates. A constant voltage difference from plate to plate generates an approximately uniform electric field. An ion which is located in the channel formed between the plates 101 is caused to drift along the channel at a constant velocity, in dependence upon the field strength, direction, and the mobility of the ion at the particular conditions of temperature, gas pressure, electric field strength, and type of bath gas. Typically, a mixture of ions including a plurality of ion species is gated into the DTIMS as a small, physically compact cloud of ions. The ions drift at velocities characteristic of each ion species, and therefore arrive at a detector at various delay times after their injection. The delay times are dependent on the ion mobility of each species of ion and therefore are characteristic of each ion species. Based on this mechanism of separation, the ions arrive at the exit grid 105a of DTIMS 80 as a transient pulse of ions. Each species of ion that has been separated in DTIMS arrives at the exit grid 105a as a transient pulse, at slightly different times from other species of ions in the mixture.

A group of ions defined by the transient opening of the entrance gate grid 105 passes along the length of the drift tube 103, and impinges upon the exit grid 105a. The exit grid 105a is operated in combination with entrance gate grid 105 in that the exit grid 105a is opened at a selected time interval after the opening of entrance gate grid 105 and then closed after another time interval. The electronics for controlling the timing of opening and closing entrance gate grid 105 and exit gate grid 105a are contained within gate grid controller 104, as shown in FIG. 8. Only those ions that pass through entrance gate grid 105 and which arrive at exit grid 105a when it is open are permitted to pass through the DTIMS 80. Ions that have passed through the DTIMS 80 then impinge upon orifice plate 84 having orifice 83 leading to the low pressure region of a differentially pumped interface of a mass spectrometer. The interface is composed of the orifice plate 84 mounted on an electrically isolating ring 85, which is in turn mounted into the outer wall 86 of the vacuum chamber of a mass spectrometer, and a skimmer cone 19. A mechanical roughing pump (not shown) pumps a space separating orifice plate 84 and skimmer cone 19. Ions that pass through the skimmer cone 19 enter the mass analyzer region of the mass spectrometer, composed in this example of a quadrupole mass analyzer 20 and a detector 44. The vacuum pumping and electronic controls of this mass spectrometer are well known, and have not been shown in FIG. 8. Of course, other mass spectrometers are known, including time-of-flight mass spectrometers, and are preferably used to detect the pulse of ions.

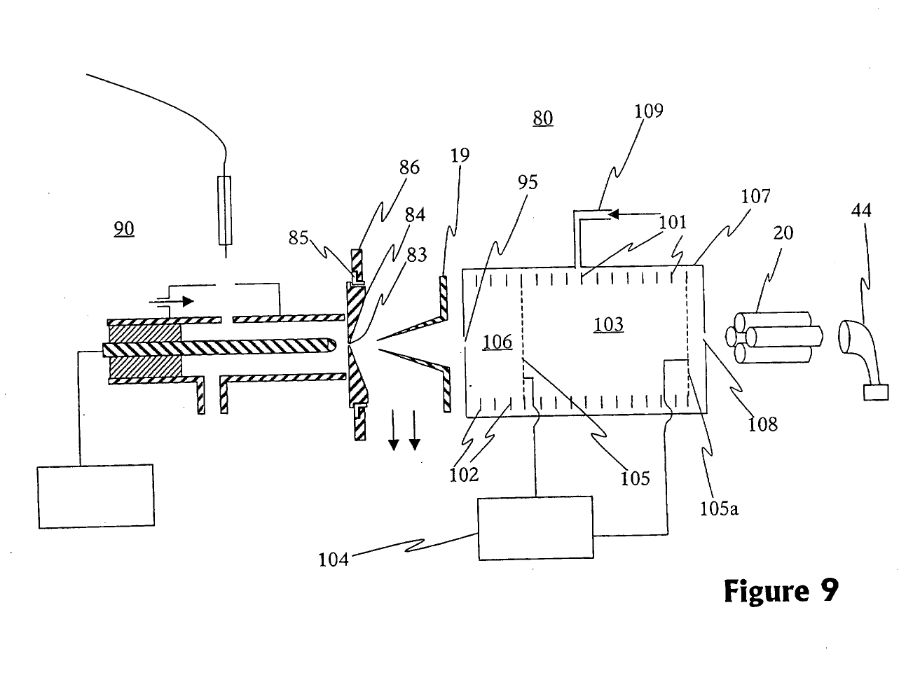

Referring to FIG. 9, shown is another embodiment of a tandem FAIMS-DTIMS according to a fifth embodiment of the present invention. Elements identical to those previously described with reference to FIG. 8 are omitted from the present discussion for the sake of brevity. The FAIMS 90 operates at high gas pressure, for instance substantially atmospheric pressure, in tandem with a DTIMS 80 operating at relatively low pressure within the vacuum chamber of a mass spectrometer. In FIG. 9, the ions which exit FAIMS 90 are directed into an orifice 83 leading to the differentially pumped region of a low pressure chamber. The space between the orifice plate 84 and the skimmer cone 19 is pumped by a mechanical pump (not shown). Once in the low pressure region, the ions travel into cell 107 having ion inlet orifice 95, an ion exit orifice 108, and a controlled gas supply 109. The pressure in this cell 107 is maintained at a level suitable for ion separation within the DTIMS 80. The DTIMS 80 includes an electronically controlled ion gating grid 105, the ions which impinge upon the gate grid 105 of DTIMS are intermittently permitted to pass into the drift region 103 of DTIMS by temporarily opening entrance gate grid 105, using gate grid controller 104. The gas within the DTIMS 80 is at sufficient pressure so that the ions drift at a constant velocity while under the influence of a uniform, constant strength electric field. Typically, the electric field is generated using a set of parallel flat plates 101 within a drift region 103, each parallel plate of the set of parallel flat plate 101 having an aperture through which ions pass, and each of which is connected to a dc power supply (not shown). The plates 101 are aligned so that the ions drift down a channel that is created by the alignment of the apertures in each of the parallel plates. The voltages applied to the individual plates are adjusted so that a uniform constant strength field is generated between the plates. A constant voltage difference from plate to plate generates an approximately uniform electric field. An ion which is located in the channel formed between the plates 101 is caused to drift along the channel at a constant velocity, in dependence upon the field strength, direction, and the mobility of the ion at the particular conditions of temperature, gas pressure, electric field strength, and type of bath gas. Typically, a mixture of ions including a plurality of ion species is gated into the DTIMS as a small, physically compact cloud of ions. The ions drift at velocities characteristic of each ion species, and therefore arrive at a detector at various delay times after their injection. The delay times are dependent on the ion mobility of each species of ion and therefore are characteristic of each ion species. Based on this mechanism of separation, the ions arrive at the exit grid 105a of DTIMS 80 as a transient pulse of ions. Each species of ion that has been separated in DTIMS arrives at the exit grid 105a as a transient pulse, at slightly different times from other species of ions in the mixture.

A group of ions defined by the transient opening of the entrance gate grid 105 passes along the length of the drift tube 103, and impinges upon the exit grid 105a. The exit grid 105a is operated in combination with entrance gate grid 105 in that the exit grid 105a is opened at a selected time interval after the opening of entrance gate grid 105 and then closed after another time interval. The electronics for controlling the timing of opening and closing entrance gate grid 105 and exit gate grid 105a are contained within gate grid controller 104, as shown in FIG. 9. Only those ions that pass through entrance gate grid 105 and which arrive at exit grid 105a when it is open are permitted to pass through the DTIMS 80. Ions that pass through the orifice 108 enter the mass analyzer region of the mass spectrometer, composed in this example of a quadrupole mass analyzer 20 and a detector 44.

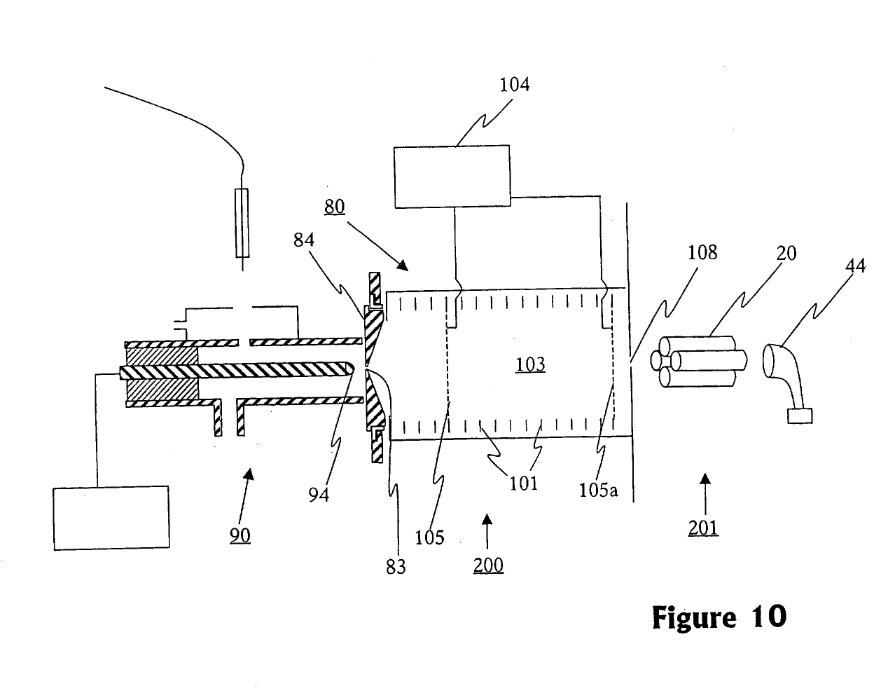

Referring to FIG. 10, shown is another embodiment of a tandem FAIMS-DTIMS according to a sixth embodiment of the present invention. Elements identical to those previously described with reference to FIG. 8 are omitted from the present discussion for the sake of brevity. The FAIMS 90 operates at high gas pressure, for instance substantially atmospheric pressure, in tandem with a DTIMS 80 operating at pressures lower than atmospheric pressure, but at pressures significantly higher than suitable for operation of a mass spectrometer. For example, the DTIMS in FIG. 10 is operated from 760 Torr to 10 Torr, but the practical pressure range of operation of a particular embodiment is dependent upon the vacuum pumping efficiency, and the dimensions of the orifices leading into and out of DTIMS.

Still referring to FIG. 10, the FAIMS 90 is substantially the same as that previously shown and described with respect to FIG. 8. As described previously, the ions which have the high field mobility properties suitable for transmission through FAIMS at the conditions of waveform amplitude (DV) and compensation voltage (CV) are accumulated near the central axis of the inner electrode at the spherical tip 94. The ions are extracted from this location by a combination of electric and gas flow forces.

The ions then pass out of FAIMS 90, through an orifice 83 in an orifice plate 84, and into a DTIMS 80 located in a chamber 200 that is maintained at a pressure suitable for operation of DTIMS 80. Only one DTIMS exit orifice 108 communicates between the chamber 200 and the mass spectrometer vacuum chamber 201. The pressure in chamber 200 is limited by the dimensions of the exit orifice 108, since a large diameter orifice permits a high flow of gas into chamber 201 if the pressure inside of chamber 200 is high. In general, if pressure in chamber 200 is high, the orifice 108 must be small and if the pressure in chamber 200 is low, the orifice 108 is optionally large.

Referring still to FIG. 10, the ions that have passed through orifice 83 impinge upon the gate grid 105 of DTIMS and are intermittently permitted to pass into the drift region 103 of DTIMS by temporarily opening entrance gate grid 105, using gate grid controller 104. The gas within the DTIMS 80 is at sufficient pressure so that the ions drift at a constant velocity while under the influence of a uniform, constant strength electric field. Typically, the electric field is generated using a set of parallel flat plates 101 within a drift region 103, each parallel plate of the set of parallel flat plate 101 having an aperture through which ions pass, and each of which is connected to a de power supply (not shown). The plates 101 are aligned so that the ions drift down a channel that is created by the alignment of the apertures in each of the parallel plates. The voltages applied to the individual plates are adjusted so that a uniform constant strength field is generated between the plates. A constant voltage difference from plate to plate generates an approximately uniform electric field. An ion which is located in the channel formed between the plates 101 is caused to drift along the channel at a constant velocity, in dependence upon the field strength, direction, and the mobility of the ion at the particular conditions of temperature, gas pressure, electric field strength, and type of bath gas. Typically, a mixture of ions including a plurality of ion species is gated into the DTIMS as a small, physically compact cloud of ions. The ions drift at velocities characteristic of each ion species, and therefore arrive at a detector at various delay times after their injection. The delay times are dependent on the ion mobility of each species of ion and therefore are characteristic of each ion species. Based on this mechanism of separation, the ions arrive at the exit grid 105a of DTIMS 80 as a transient pulse of ions. Each species of ion that has been separated in DTIMS arrives at the exit grid 105a as a transient pulse, at slightly different times from other species of ions in the mixture.

A group of ions defined by the transient opening of the entrance gate grid 105 passes along the length of the drift tube 103, and impinges upon the exit grid 105a. The exit grid 105a is operated in combination with entrance gate grid 105 in that the exit grid 105a is opened at a selected time interval after the opening of entrance gate grid 105 and then closed after another time interval. The electronics for controlling the timing of opening and closing entrance gate grid 105 and exit gate grid 105a are contained within gate grid controller 104, as shown in FIG. 10. Only those ions that pass through entrance gate grid 105 and which arrive at exit grid 105a when it is open are permitted to pass through the DTIMS 80 and pass through a DTIMS exit orifice 108 leading to the low pressure region of the mass spectrometer. Ions that pass through the orifice 108 enter the mass analyzer region of the mass spectrometer, composed in this example of a quadrupole mass analyzer 20 and a detector 44. The vacuum pumping and electronic controls of this mass spectrometer are well known, and are not shown in FIG. 10.

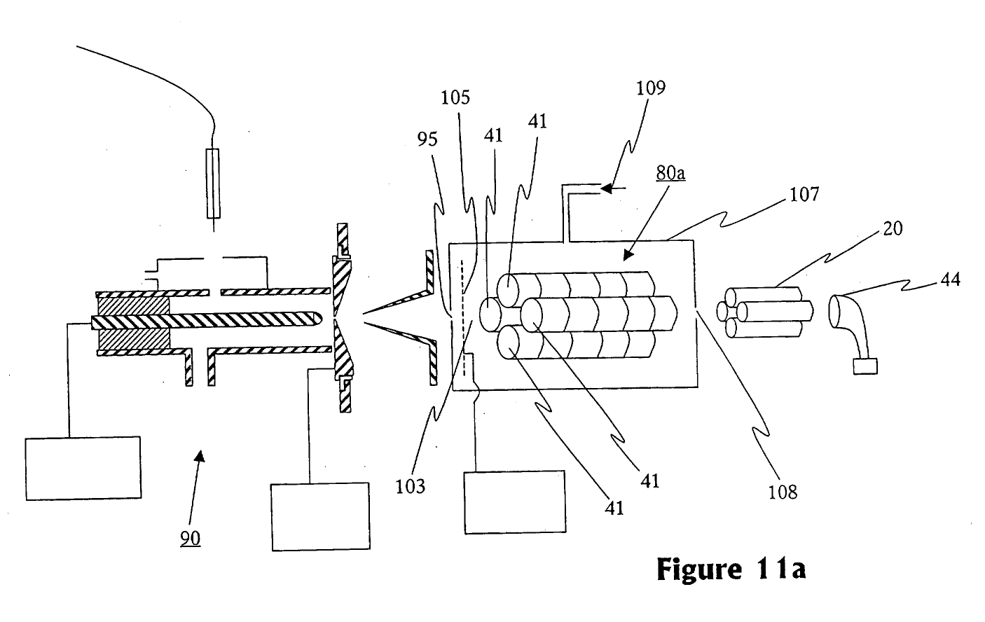

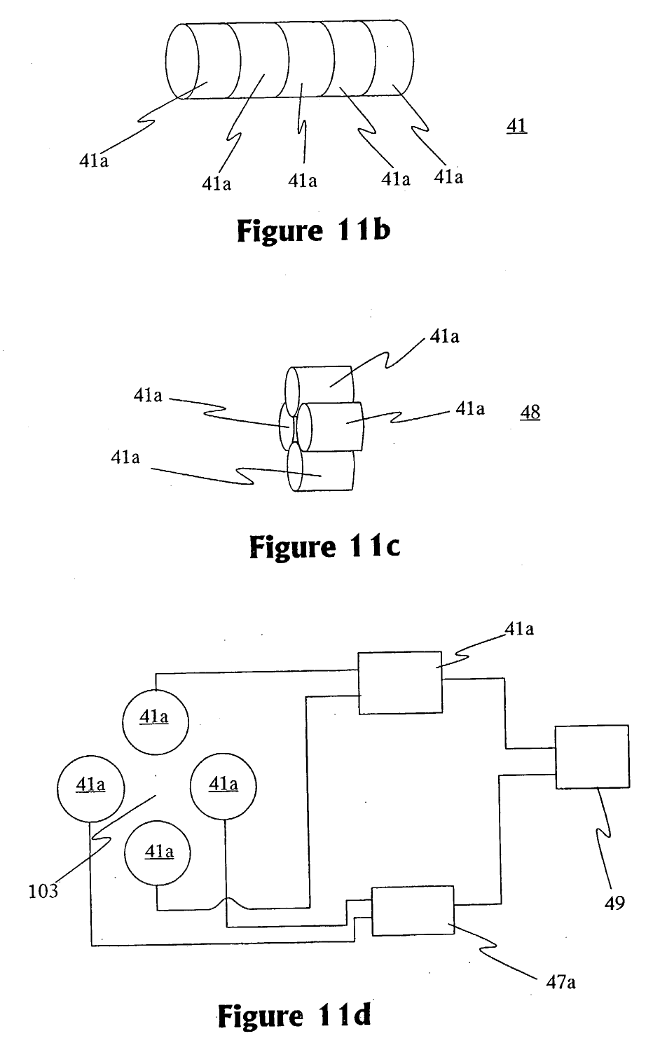

Referring now to FIG. 11a, shown is another embodiment of a tandem FAIMS-DTIMS according to a seventh embodiment of the present invention. Elements identical to those previously described with reference to FIG. 8 are omitted from the present discussion for the sake of brevity. As shown in FIG. 11a, the equally spaced electrodes 101 are replaced by a series of segmented cylindrical rods 41. The rods 41 together form a radio frequency (rf) rf-only quadrupole indicated generally by reference numeral 80a. The rf-only operation of the quadrupole is well known, and serves to contain the ions as close to the central longitudinal axis of the device as is possible. Referring now to FIG. 11b, a quadrupole rod assembly, of the rf-only quadrupole 80a, is shown generally at 41. Each quadrupole rod assembly 41 further comprises a plurality of electrically isolated segments 41a in a spaced apart coaxial arrangement. Referring now to FIG. 11c, each set of four rod-segments 41a that are at equal position along the length of the four quadrupole rod assemblies 41 of the rf-only quadrupole 80a, also forms a separate rf-only quadrupole assembly, which is shown generally at 48, for transmitting ions absent mass separation. Referring now to FIG. 11d, a first pair of opposing segments 41a is connected to a first electrical controller 47a for applying a first sinusoidal waveform thereto, and a second pair of opposing segments 41a is connected to a second electrical controller 47b for applying a second sinusoidal waveform thereto, wherein the first sinusoidal waveform is 180 degrees out of phase relative to the second sinusoidal waveform. Still referring to FIG. 11d, the first and the second pairs of opposing segments 41a are additionally connected to a same dc offset voltage generator 49. Each rf-only quadrupole assembly 48 along the length of the four quadrupole rod assemblies 41 are held at a series of equally separated dc offset voltages, in order to generate a uniform electric field to pull the ions along the length of the drift region 103. For simplicity, the power supplies, and the means of application of the rf-voltages and the dc voltages are not shown in FIG. 11a. This segmented quadrupole is housed within a cell 107, which has an ion inlet orifice 95, and ion outlet orifice 108, and a controlled gas supply 109. The pressure in this cell 107 is maintained at a suitable level for ion separation within the DTIMS 80a. The cluster of ions, defined by the rapid opening and closing of the gate grid 105, passes along the length of the drift tube 103, and pass through a DTIMS exit orifice 108 leading to the low pressure region of the mass spectrometer. Ions that pass through the orifice 108 enter the mass analyzer region of the mass spectrometer, composed in this example of a quadrupole mass analyzer 20 and a detector 44. The vacuum pumping and electronic controls of this mass spectrometer are well known, and are not shown in FIG. 11a. Of course, other mass spectrometers are known, including time-of-flight mass spectrometers, and are preferably used to detect the pulse of ions.

The embodiments of the present invention described above and with reference to FIGS. 8 to 11 are suitable for performing separations that are other than possible using either DTIMS or FAIMS alone. That is, ions are separated on the basis of their change in mobility at high electric fields according to FAIMS, and also separated on the basis of the absolute ion mobility itself in DTIMS. This combination of separation methods leads to better separation of ions from complex mixtures and such that chromatographic and electrophoretic methods of separation are other than necessary. Advantageously, the separations occur on time scales in milliseconds rather than minutes, which is needed to achieve comparable separations using chromatographic and electrophoretic techniques.

Although the tandem arrangement of FAIMS 90 and DTIMS 80 appears to have the limitation of combining a continuous flow device, for instance FAIMS 90, with a device that creates a transient pulse of ions, for instance DTIMS 80, the total effective duty cycle of this unit is improved by using a special version of FAIMS 90 which is capable of ion trapping, as was described above with reference to FIGS. 8 to 11. The combination of an ion-trapping version of FAIMS 90 together with a DTIMS 80 is advantageous because the continuous flow of ions from the source, for instance an electrospray ionization source, is optionally converted to a pulsed flow using the trapping FAIMS 90. As explained above, in the ion trapping FAIMS 90, the electrode voltages are maintained in a state whereby the ions that are separated by FAIMS 90 cannot escape from near the curved dome 94 located at one end of the inner FAIMS 90 electrode. Intermittently the voltages are changed, thereby releasing the ions that have collected near the curved dome 94 of the inner electrode of FAIMS 90. The ions then flow out of FAIMS 90 as a transient pulse. The successful tandem operation of a trapping FAIMS 90 and DTIMS 80 then requires the timing of the opening of the gate grid of the DTIMS 80 to correspond to the arrival time of the pulse of ions from FAIMS 90. This effectively increases the overall duty cycle of the system by ensuring that the minimum number of ions are lost because of the intermittent operation of the gating grid 105 of DTIMS 80.

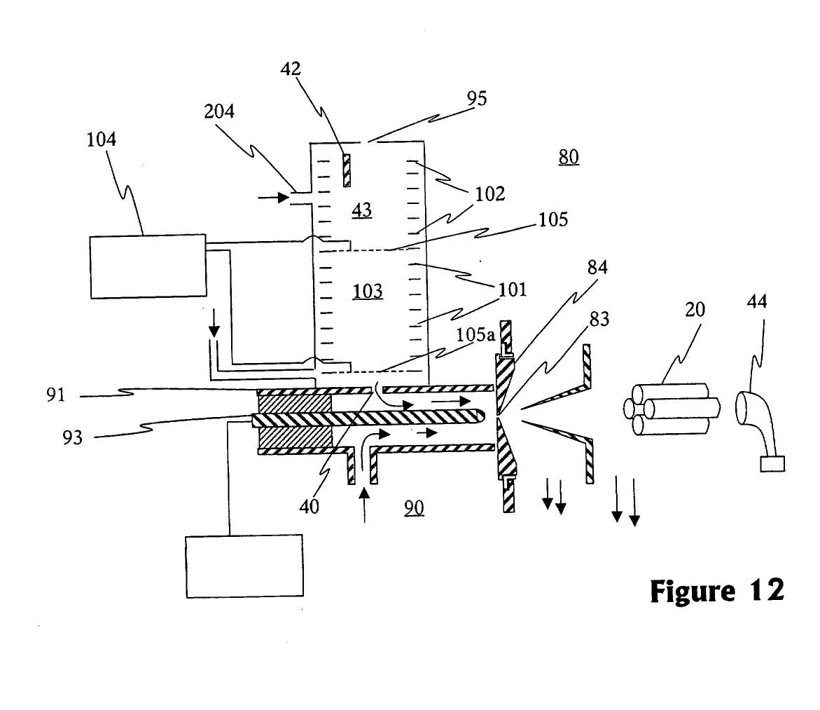

Of course, optionally the order of ion separation is reversed, to yield a DTIMS-FAIMS apparatus as shown in FIG. 12, according to an eighth preferred embodiment of the present invention. Elements identical to those previously described with reference to FIG. 8 are omitted from the present discussion for the sake of brevity. In this case, the FAIMS 90 is operated in a continuous flowing mode, or in ion trapping mode. In this latter mode, any of the ions which are passed through the DTIMS 80 and into FAIMS 90 are optionally trapped temporarily, and extracted out of FAIMS 90 at a time appropriate to the detection system. Because FAIMS 90 itself is not sensitive to the arrival time of the ions which have passes through DTIMS 80, provision must be made to select only the ions which are arriving at a particular time, for passage into FAIMS 90.

Referring still to FIG. 12, the system is composed of DTIMS 80 and FAIMS 90 in which both are operating at high pressure, for instance substantially atmospheric pressure. Ions selected to pass both devices are transferred to an ion detection system, optionally shown as a quadrupole mass analyzer 20 and a detector 44. The vacuum pumping and electronic controls of this mass spectrometer are well known, and are not shown in FIG. 12. In the present embodiment, the ions are produced via the high energy particles emitted by a radioactive foil 42. Of course, any other suitable ionization source is used optionally in place of the ionization source 42. A gas containing the compounds for analysis enters the DTIMS 80 through a sample introduction port 204. The ions that are formed in the vicinity of the radioactive foil 42 are swept toward grid 105 along a region 43 of DTIMS by an electric field generated by a set of evenly spaced plates 102, to which a set of uniformly incremented voltages is applied. Of course, optionally a set of uniformly decremented voltages is applied to the series of evenly spaced plates 102, in dependence upon the polarity of the ion charge. This region 43 serves to move the ions to an isothermal region inside DTIMS 80, and keep the grid 105 as far as possible from the thermal, and gas flow influences of the orifice 204.

Still referring to FIG. 12, the ions that impinge upon the gate grid 105 of DTIMS 80 are intermittently, for instance via a temporarily open gate grid, permitted to pass into the drift region 103 of DTIMS. The drift region is composed of a series of equally spaced electrodes 101 which are held at a series of equally separated voltages to generate a uniform electric field to pull the ions along the length of the drift region 103. The power supplies, and the means of application of the voltages are well known, and are not shown in FIG. 12. The group of ions defined by the transient opening of the gate grid 105 passes along the length of the drift tube 103, and impinges upon an exit gate grid 105a. This exit gate grid 105a is operated in conjunction with entrance gate grid 105 in that the exit grid 105a is opened at a selected time interval after the opening of entrance gate grid 105 and then closed after another time interval. The electronics and computer control of this timing are contained within gate grid controller 104. Only those ions that pass through the entrance gate grid 105 and arrive at exit gate grid 105a when it is open are permitted to pass through the DTIMS. The exit grid 105a is closed at all other times, and ions cannot pass through. The ions, which have thus been selected from the mixture by their mobility in DTIMS, for instance in dependence upon the time of drift along the region 103 between the entrance gate grid 105 and the exit grid 105a, pass out of DTIMS 80 into FAIMS 90 through an orifice 40 in the outer electrode 91 of FAIMS 90.

Still referring to FIG. 12, those ions that pass through the orifice 40 in the outer electrode of FAIMS 90 are separated inside the analyzer region of FAIMS 90, and in this embodiment, focused near the end of the curved dome shaped terminus 94 of the inner electrode 93. The ions are sampled into the mass spectrometer 20 through orifice 83 in the orifice plate 84. The differentially pumped region and the mass analyzer are shown as a quadrupole mass spectrometer 20 in FIG. 12, however, optionally the ion detector is selected from the group including: ion trap mass spectrometers; time-of-flight mass spectrometers; ion cyclotron mass spectrometers; and, electrical current detectors.

An alternative method of selecting a pulse of ions that has passed through DTIMS comprises varying the dc voltage offset of FAIMS, while maintaining DV and CV inside FAIMS constant. If FAIMS is held at a higher offset voltage than the outlet aperture of DTIMS, the ions cannot enter FAIMS. At the time of the arrival of the pulse of ions of interest, the FAIMS dc offset voltage is decreased temporarily, and allows the ions that are arriving at that moment to pass into FAIMS. The dc voltage applied to FAIMS is again raised after the arrival of these ions, and any later arriving ions are rejected. This is a time-dependent ion selection after the separation of ions in the drift tube of DTIMS.

Of course, the sequence of combination of DTIMS and FAIMS is also controlled by several practical considerations. As a DTIMS 80 is normally operated at elevated temperatures, one practical consideration is how to interface an electrospray ionization source and DTIMS 80. One way of overcoming this difficulty is to design a system in which the ions are separated first in FAIMS 90 at room temperature, and the ions which have successfully passed through FAIMS 90 are in turn separated in a DTIMS 80, which is optionally operated at elevated temperatures. This DTIMS 80 would be thermally isolated from FAIMS 90 if the temperature difference between these units was more than, say, 30° C. In practice, if the ion-outlet orifice 95 of the FAIMS 90 is mounted to be a few millimeters from the ion gating grid of DTIMS 80, and if the temperature difference between the FAIMS 90 and DTIMS 80 is large, then a temperature control for FAIMS 90 is necessary.

The tandem DTIMS-FAIMS systems described above are most compatible with ionization techniques in which the sample is presented to the DTIMS in the gas phase, for example through corona discharge ionization. Although electrospray ionization is optionally used with DTIMS, if the DTIMS is held at elevated temperatures, for example 150° C., then a more complex cooling system for electrospray ionization is required. Absent an appropriate cooling system, the hot DTIMS causes boiling of the solvents used in electrospray ionization as the solvents and analytes pass through the electrospray needle. The boiling of the solvent reduces the effectiveness of the electrospray ionization source. As the operation of electrospray ionization at a location more remote from the DTIMS gating grid results in loss of ions in transmission between the ESI and DTIMS, it is advantageous to operate these devices in close proximity to maintain high sensitivity.

It is a limitation of DTIMS that there is no mechanism for preventing the expansion of the ion cloud during passage through the DTIMS drift region. Thus ion losses occur, and DTIMS sensitivity is reduced. This means that only a sub-sample of the original ions are transmitted out of the DTIMS device and into the FAIMS. Ion transmission efficiency is improved by increasing the diameter of the aperture 40 between DTIMS and into the FAIMS. Since in one embodiment, FAIMS is operating at a same gas pressure as DTIMS, the large orifice does not result in abnormal gas flows, and the DTIMS operates in a mode analogous to operation using an electrical current detector. If the DTIMS and FAIMS are operated at very different temperatures, for example more than a 30° C. difference, then provision is required to ensure that both are maintained at the appropriate temperature, with minimization of the impact of the temperature of one device upon the other.

Of course, while the FAIMS devices described with reference to FIGS. 4 to 12 have all been specific examples of FAIMS devices having a cylindrical electrode geometry, it is entirely contemplated by the present inventors that FAIMS devices having other than cylindrical electrode geometry are equally suitable for use. For example, as disclosed in a copending PCT application in the name of R. Guevremont, and R. Purves, a FAIMS devices having n parallel, flat plate electrodes, wherein n 3. Additionally, at least an edge of at least one of the n parallel, flat plate electrodes is optionally provided with at least a smooth curve joining two flat plate surfaces on opposite sides thereof. Further optionally, the n parallel, flat plate electrodes are replaced with n curved, spaced apart electrodes, wherein n3, which are also optionally provided with at least a smooth curve joining two curved plate surfaces on opposite sides thereof. Of course, any of the plate electrodes described above are further optionally shaped for directing the ions generally inwardly towards a central axis of the FAIMS device, such that an approximately collimated beam of ions is provided through an ion-outlet orifice of an ion-outlet electrode of the FAIMS device.

Of course, numerous other embodiments could be envisioned, without departing significantly from the teachings of the present invention.

What is claimed is:

1. A method for separating ions, comprising the steps of:
a) providing a first analyzer region defined by a space between first and second spaced apart electrodes, the first analyzer region in communication with a first ion inlet and a first ion outlet, the first ion inlet for receiving ions for introduction into the first analyzer region, the first ion outlet for providing ions from the first analyzer region;
b) providing a second analyzer region in operational communication with the first analyzer region, the second analyzer region in communication with a second ion inlet and a second ion outlet, the second ion inlet for receiving ions for introduction into the second analyzer region, and the second ion outlet for providing ions from the second analyzer region;
c) providing ions to one of the first analyzer region and the second analyzer region;
d) coupling ions from the ion outlet of the one of the first and second analyzer regions to the ion inlet of the other of the first and second analyzer regions;
e) providing a first asymmetric waveform and a first direct-current compensation voltage, to at least one of the first and second electrodes, to form an electric field therebetween, the first asymmetric waveform for effecting a difference in net displacement between two different ions in the time of one cycle of the applied first asymmetric waveform;
f) setting the first compensation voltage for effecting a first separation of the ions to support selective transmission of a first subset of the ions within the first analyzer region; and,
g) providing conditions within the second analyzer region for effecting a second separation of ions therein to support selective transmission of a second subset of the ions within the second analyzer region, wherein one of the first and second subsets of ions is a subset of the other.

2. A method according to claim 1 wherein the ion outlet of the one of the first and second analyzer regions and the ion inlet of the other of the first and second analyzer regions is a same port.

3. A method according to claim 1 wherein the second separation is a second different separation and wherein the conditions provided within the second analyzer region are different from the conditions provided within the first analyzer region.

4. A method according to claim 1 including the step of: providing a flow of at least a carrier gas through the first analyzer region.

5. A method according to claim 4, wherein the second analyzer region is an analyzer region within a FAIMS, the second analyzer region defined by a space between at least third and fourth spaced apart electrodes

6. A method according to claim 5 comprising the step of: providing a flow of at least a carrier gas through the second analyzer region.

7. A method according to claim 6 wherein step g) comprises the step of:
g1) providing a second different carrier gas, the second different carrier gas having a second different predetermined composition than the first carrier gas, within the second analyzer region.

8. A method according to claim 7 wherein one of the first and the second different carrier gas includes the other carrier gas and at least one additional gaseous component other than the ions.

9. A method according to claim 7 wherein step g) comprises the steps of:
providing a second different asymmetric waveform and a second different direct-current compensation voltage, to at least one of the third and fourth electrodes, to form an electric field therebetween for effecting a difference in net displacement between the ions in the time of one cycle of the applied second different asymmetric waveform;
setting the second different compensation voltage for effecting a second different separation of the ions to support selective transmission of a subset thereof within the second analyzer region,
wherein the second different compensation voltage is determined in dependence upon the composition of the carrier gas having a second different predetermined composition within the second analyzer region.

10. A method according to claim 9, comprising the step of applying an extraction voltage at one of the first and the second ion outlet for extracting the selectively transmitted subset of the ions.

11. A method according to claim 5 wherein step g) comprises the steps of:
providing a second different asymmetric waveform and a second different direct-current compensation voltage, to at least one of the third and fourth electrodes, to form an electric field therebetween for effecting a difference in net displacement between the ions in the time of one cycle of the applied second different asymmetric waveform;
setting the second different compensation voltage for effecting a second different separation of the ions to support selective transmission of a subset thereof within the second analyzer region.

12. A method according to claim 11 comprising the additional step of applying an extraction voltage at one of the first and the second ion outlet for extracting the selectively transmitted subset of ions.

13. A method according to claim 1 wherein the second analyzer region is an analyzer region within a FAIMS, the second analyzer region defined by a space between a third electrode and at least one of the first electrode and the second electrode, the second analyzer region being in communication with a second gas inlet and a second gas outlet, the second gas inlet for introducing a flow of at least a carrier gas through the second analyzer region and out of the second gas outlet.

14. A method according to claim 13 wherein step g) comprises the additional step of:
providing a first carrier gas within the first analyzer region for transporting ions therein; and, providing within the second analyzer region a second different carrier gas having a second different predetermined composition from the first carrier gas.

15. A method according to claim 14 wherein one of the first and the second different carrier gas includes the other carrier gas and at least one additional gaseous component other than the ions.

16. A method according to claim 14 wherein step g) comprises the steps of:
g2) providing a second asymmetric waveform and a second direct-current compensation voltage wherein at least one of the second asymmetric waveform and a second direct-current compensation voltage is different from the first, to at least one of the third electrode and the at least some of one of the first electrode and the second electrode, to form an electric field therebetween, the second different asymmetric waveform for effecting a difference in net displacement between two different ions in the time of one cycle of the applied second different asymmetric waveform;
g3) setting the second different compensation voltage for effecting a second different separation of the ions to support selective transmission of a subset thereof within the second analyzer region,
wherein the second different compensation voltage is determined in dependence upon the composition of the carrier gas having a second different predetermined composition within the second analyzer region.

17. A method according to claim 16 comprising the additional step of applying an extraction voltage at one of the first and the second ion outlet for extracting the selectively transmitted subset of ions.

18. A method according to claim 13 wherein step g) comprises the steps of:
g1) providing a second different asymmetric waveform and a second different direct-current compensation voltage, to at least one of the third electrode and the at least some of one of the first electrode and the second electrode, to form an electric field therebetween, the second different asymmetric waveform for effecting a difference in net displacement between the ions in the time of one cycle of the applied second different asymmetric waveform;
g2) setting the second different compensation voltage for effecting a second different separation of the ions to support selective transmission of a subset thereof within the second analyzer region.

19. A method according to claim 18 comprising the additional step of applying an extraction voltage at one of the first and the second ion outlet for extracting the selectively transmitted subset of ions.

20. A method according to claim 1 wherein the second analyzer region is an analyzer region within a DTIMS is defined by a space between a third electrode having the second ion inlet and a spaced apart fourth electrode having a second ion outlet, the second ion inlet and the second ion outlet being approximately aligned along a path normal to each of said third and fourth electrodes.

21. A method according to claim 20 including the step of selectively opening and closing at least an ion gate grid disposed between the third and fourth electrodes for selectively allowing ions to pass therethrough.

22. A method according to claim 1 wherein the second analyzer region is an analyzer region within a TGFIMS is defined by a space between a third electrode having the second ion inlet and a spaced apart fourth electrode having a second ion outlet, the second ion outlet being located at a position that is approximately transversely offset from a path aligned with the second ion inlet, the second analyzer region being in communication with a second gas inlet and a second gas outlet for providing a flow between the electrodes and approximately transversely across the path.

23. A method according to claim 22 including the step of providing a voltage difference between the third and fourth electrodes so as to direct ions from the second ion inlet to the second ion outlet.

24. A method according to claim 23 including the step of providing a transverse gas flow between the third and fourth electrodes to add a transverse component to a path an ion traverses between the third and fourth electrodes.

25. A method according to claim 24 including the step of adjusting at least one of the transverse gas flow, the electric field between the third and fourth electrodes, and the downstream position of the second ion outlet so as to allow ions to pass through the second ion outlet.

26. An apparatus for separating ions, comprising:
a first analyzer comprising two spaced apart electrodes defining a first analyzer region therebetween, the first analyzer region having a first ion inlet for receiving ions for introduction into the first analyzer region and a first ion outlet for providing ions from the first analyzer region;
a second analyzer in fluid communication with the first analyzer, the second analyzer comprising a second ion inlet for receiving ions for introduction into the second analyzer region, a second ion outlet for providing ions from the second analyzer region and two spaced apart electrodes defining a second analyzer region therebetween and in communication with the second ion inlet and the second ion outlet;
an ionization source for providing ions to one of the first analyzer region and the second analyzer region;
wherein the first and second analyzers are disposed for coupling ions from one of the first and second analyzer regions to the other of the first and second analyzer regions;
a first voltage source for providing a first asymmetric waveform and a first direct-current compensation voltage to at least one of the two spaced apart electrodes of the first analyzer, to form a first electric field therebetween, the first asymmetric waveform for, in use, effecting a difference in net displacement between the ions in the time of one cycle of the applied first asymmetric waveform and the first compensation voltage for, in use, effecting a first separation of the ions by supporting selective transmission of a first subset of the ions within the first analyzer region; and,
a second voltage source for providing at least a voltage to at least one of the two spaced apart electrodes of the second analyzer, to form an electric field therebetween, the electric field for effecting a second different separation of the ions to support selective transmission of a second subset of ions within the second analyzer region, wherein one of the first and second subsets of ions is a subset of the other.

27. The apparatus claimed in claim 26 wherein the second analyzer comprises and wherein the second analyzer is a FAIMS analyzer.

28. An apparatus according to claim 27 wherein the first analyzer region comprises a first gas inlet and a first gas outlet in fluid communication therewith wherein the second analyzer region comprises a second gas inlet and a second gas outlet in fluid communication therewith.

29. An apparatus according to claim 28 comprising:
a first gas source in fluid communication with the first gas inlet for providing a gas flow including a first gas through the first analyzer region; and,
a second gas source in fluid communication with the second gas inlet for providing a gas flow including a second other gas through the second analyzer region.

30. An apparatus according to claim 27 wherein the second voltage source is an electrical controller for providing a second asymmetric waveform and a second direct-current compensation voltage to at least one of the two electrodes of the second analyzer to form an electric field therebetween that effects a difference in net displacement between the ions in the time of one cycle of the applied second asymmetric waveform and the second compensation voltage for effecting a second separation of the ions by supporting selective transmission of a subset of the ions within the second analyzer region.

31. The apparatus claimed in claim 27 wherein one of the two electrodes of the first analyzer is a same electrode as one of the two electrodes of the second analyzer.

32. An apparatus according to claim 27 wherein the two electrodes of the second analyzer comprise a third electrode having in cross section an approximately continuous periphery;
a fourth electrode having in cross section an approximately continuous periphery approximately equidistant from the third electrode over a region thereof and having the second ion inlet for introduction of ions and the second ion outlet for extraction of ions in the approximately continuous periphery; and,
a contact on at least one of the third and fourth electrode for providing an asymmetric electric field between the third and fourth electrode;
wherein, in use, ions flow through the second ion inlet about the approximately continuous periphery of the first electrode and out the second ion outlet wherein a similar electric field is present on opposing sides of the first electrode at an end proximate the second ion outlet.

33. An apparatus according to claim 32 wherein the third electrode has an approximately continuous smooth curved periphery along any cross section thereof.

34. An apparatus according to claim 33 wherein the third electrode is cylindrical and the fourth electrode is a concentric cylinder and wherein, in use, ions flow about a circular cross section of the third electrode from the second ion inlet on one side of the circular cross section to the second ion outlet on a second opposing side of the circular cross section.

35. An apparatus according to claim 26 wherein the at least two electrodes of the second analyzer are selected from the group including: concentric cylindrical electrodes; parallel, flat plate electrodes; and, curved plate electrodes.

36. An apparatus according to claim 26 wherein the second analyzer region is an analyzer region within a DTIMS, the two electrodes of the second analyzer comprising a third electrode including the second ion inlet and a fourth electrode including the second ion outlet, the second ion inlet and the second ion outlet being aligned along a path approximately normal to each of said third and fourth electrodes.

37. An apparatus according to claim 36 wherein the second voltage source is a voltage generator for generating between the third and fourth electrodes a voltage difference for, in use, directing ions from the second ion inlet to the second ion outlet.

38. An apparatus according to claim 37 comprising at least an ion gate grid operable between an open and a closed position for selectively allowing selected ions to pass therethrough when in an open position and disposed between the third and fourth electrodes.

39. An apparatus according to claim 26 wherein the second analyzer region is an analyzer region within a TGFIMS, one of the two electrodes of the second analyzer including the second ion inlet and the other of the two electrodes including the second ion outlet, the second ion inlet located at a position that is approximately transversely offset from a path aligned with the second ion outlet.

40. An apparatus according to claim 39 wherein the second voltage source is a voltage generator for generating a voltage difference for, in use, directing ions from the second ion inlet to the second ion outlet between the two electrodes of the second analyzer, the voltage difference.

41. An apparatus according to claim 40 comprising a second gas outlet and a second gas inlet for providing a gas flow between the two electrodes of the second analyzer and through the second gas outlet for, in use, introducing a transverse component to ion paths between the two electrodes of the second analyzer region.

42. An apparatus according to claim 41 wherein one of the two electrodes of the second analyzer is a same electrodes as one of the two electrodes of the first analyzer.
